(19) United States
(12) Patent Application Publication
(10) Pub. No.: US 2026/0292203 A1
(43) Pub. Date: Sep. 24, 2026

(54) EXTRAPOLATION INTRA PREDICTION MODEL INHERITANCE

(71) Applicant: MEDIATEK INC., Hsinchu City (TW)

(72) Inventors: Cheng-Yen CHUANG, Hsinchu City (TW); Tzu-Der CHUANG, Hsinchu City (TW); Yi-Wen CHEN, San Jose, CA (US); Ching-Yeh CHEN, Hsinchu City (TW); Chih-Wei HSU, Hsinchu City (TW); Yu-Wen HUANG, Hsinchu City (TW)

(21) Appl. No.: 19/472,051

(22) PCT Filed: Jul. 5, 2024
(86) PCT No.: PCT/CN2024/104084

§ 371 Date: Oct. 2, 2025

Related U.S. Application Data
(60) Provisional application No. 63/525,432, filed on Jul. 7, 2023.

(51) Int. Cl. H04N 19/159; H04N 19/117; H04N 19/176; H04N 19/196; H04N 19/82

(52) U.S. Cl. CPC H04N 19/159; H04N 19/117; H04N 19/176; H04N 19/196; H04N 19/82

(57) ABSTRACT

A method for using Extrapolation Intra Prediction (EIP) to code pixel blocks is provided. A video coder receives data to be encoded or decoded as a current block of pixels of a current picture of a video. The video coder inherits a previously used linear model for extrapolation intra prediction (EIP) that is derived based on samples in a template region neighboring a previously coded block, the template region occupying an area that extends beyond at least one of top and left edges of the previously coded block. The video coder applies the inherited linear model to generate a predictor of the current block by using reconstructed samples or predicted samples of the current block as input to a filter to generate samples of the predictor. The video coder encodes or decodes the current block by using the predictor.

### CROSS REFERENCE TO RELATED PATENT APPLICATION(S)

The present disclosure is part of a non-provisional application that claims the priority benefit of U.S. Provisional Patent Application No. 63/525,432 filed on 7 Jul. 2023. Content of above-listed applications are herein incorporated by reference.

### TECHNICAL FIELD

The present disclosure relates generally to video coding. In particular, the present disclosure relates to methods of coding pixel blocks by extrapolation intra prediction (EIP).

### BACKGROUND

Unless otherwise indicated herein, approaches described in this section are not prior art to the claims listed below and are not admitted as prior art by inclusion in this section.

High-Efficiency Video Coding (HEVC) is an international video coding standard developed by the Joint Collaborative Team on Video Coding (JCT-VC). HEVC is based on the hybrid block-based motion-compensated DCT-like transform coding architecture. The basic unit for compression, termed coding unit (CU), is a 2N×2N square block of pixels, and each CU can be recursively split into four smaller CUs until the predefined minimum size is reached. Each CU contains one or multiple prediction units (PUs).

Versatile video coding (VVC) is the latest international video coding standard developed by the Joint Video Expert Team (JVET) of ITU-T SG16 WP3 and ISO/IEC JTC1/SC29/WG11. The input video signal is predicted from the reconstructed signal, which is derived from the coded picture regions. The prediction residual signal is processed by a block transform. The transform coefficients are quantized and entropy coded together with other side information in the bitstream. The reconstructed signal is generated from the prediction signal and the reconstructed residual signal after inverse transform on the de-quantized transform coefficients. The reconstructed signal is further processed by in-loop filtering for removing coding artifacts. The decoded pictures are stored in the frame buffer for predicting the future pictures in the input video signal.

In VVC, a coded picture is partitioned into non-overlapped square block regions represented by the associated coding tree units (CTUs). The leaf nodes of a coding tree correspond to the coding units (CUs). A coded picture can be represented by a collection of slices, each comprising an integer number of CTUs. The individual CTUs in a slice are processed in raster-scan order. A bi-predictive (B) slice may be decoded using intra prediction or inter prediction with at most two motion vectors and reference indices to predict the sample values of each block. A predictive (P) slice is decoded using intra prediction or inter prediction with at most one motion vector and reference index to predict the sample values of each block. An intra (I) slice is decoded using intra prediction only.

A CTU can be partitioned into one or multiple non-overlapped coding units (CUs) using the quadtree (QT) with nested multi-type-tree (MTT) structure to adapt to various local motion and texture characteristics. A CU can be further split into smaller CUs using one of the five split types: quad-tree partitioning, vertical binary tree partitioning, horizontal binary tree partitioning, vertical center-side triple-tree partitioning, horizontal center-side triple-tree partitioning.

Each CU contains one or more prediction units (PUs). The prediction unit, together with the associated CU syntax, works as a basic unit for signaling the predictor information. The specified prediction process is employed to predict the values of the associated pixel samples inside the PU. Each CU may contain one or more transform units (TUs) for representing the prediction residual blocks. A transform unit (TU) is comprised of a transform block (TB) of luma samples and two corresponding transform blocks of chroma samples and each TB correspond to one residual block of samples from one color component. An integer transform is applied to a transform block. The level values of quantized coefficients together with other side information are entropy coded in the bitstream. The terms coding tree block (CTB), coding block (CB), prediction block (PB), and transform block (TB) are defined to specify the 2-D sample array of one-color component associated with CTU, CU, PU, and TU, respectively. Thus, a CTU consists of one luma CTB, two chroma CTBs, and associated syntax elements. A similar relationship is valid for CU, PU, and TU.

For each inter-predicted CU, motion parameters consisting of motion vectors, reference picture indices and reference picture list usage index, and additional information are used for inter-predicted sample generation. The motion parameter can be signalled in an explicit or implicit manner. When a CU is coded with skip mode, the CU is associated with one PU and has no significant residual coefficients, no coded motion vector delta or reference picture index. A merge mode is specified whereby the motion parameters for the current CU are obtained from neighbouring CUs, including spatial and temporal candidates, and additional schedules introduced in VVC. The merge mode can be applied to any inter-predicted CU. The alternative to merge mode is the explicit transmission of motion parameters, where motion vector, corresponding reference picture index for each reference picture list and reference picture list usage flag and other needed information are signalled explicitly per each CU.

### SUMMARY

The following summary is illustrative only and is not intended to be limiting in any way. That is, the following summary is provided to introduce concepts, highlights, benefits and advantages of the novel and non-obvious techniques described herein. Select and not all implementations are further described below in the detailed description. Thus, the following summary is not intended to identify essential features of the claimed subject matter, nor is it intended for use in determining the scope of the claimed subject matter.

Some embodiments of the disclosure provide a method for using Extrapolation Intra Prediction (EIP) to code pixel blocks is provided. A video coder receives data to be encoded or decoded as a current block of pixels of a current picture of a video. The video coder inherits a previously used linear model for EIP that is derived based on samples in a template region neighboring a previously coded block, the template region occupying an area that extends beyond at least one of top and left edges of the previously coded block. The video coder applies the inherited linear model to generate a predictor of the current block by using reconstructed samples or predicted samples of the current block as input to a filter to generate samples of the predictor. The video coder encodes or decodes the current block by using the predictor.

In some embodiments, inheriting the linear model includes inheriting a set of filter coefficients, offset values to be applied to filter taps corresponding to the set of filter coefficients, and maximum and minimum values for constraining the output of the linear model. In some embodiments, inheriting the linear model also includes inheriting information regarding the derivation of the linear model. The derivation information may include a selection of a type of template region from multiple types of template region comprising above template region type, left template region type, and above-left template region type. The derivation information may also include a selection of a filter kernel type from multiple different filter kernel types having different shapes.

The linear model may be a spatial candidate inherited from a spatial neighbor of the current block. The linear model may be a non-adjacent spatial candidate inherited from a non-adjacent spatial neighbor of the current block. The inherited linear model may be a historical candidate identified by using a history table that stores a history of one or more previously used linear models. The linear model may be a temporal candidate inherited from a neighboring position of a corresponding position of the current block in a reference picture, with the neighboring position constrained to be within a region in the reference picture that is defined based on the corresponding position of the current block in the reference picture. In some embodiments, the video coder constructs a candidate list that includes one or more linear models, such that inheriting the linear model includes receiving a selection of the linear model from the constructed candidate list.

### BRIEF DESCRIPTION OF THE DRAWINGS

The accompanying drawings are included to provide a further understanding of the present disclosure, and are incorporated in and constitute a part of the present disclosure. The drawings illustrate implementations of the present disclosure and, together with the description, serve to explain the principles of the present disclosure. It is appreciable that the drawings are not necessarily in scale as some components may be shown to be out of proportion than the size in actual implementation in order to clearly illustrate the concept of the present disclosure.

FIGS. 1A-C illustrate three types of filter kernels having fifteen inputs and generating one output that may be used by EIP.

FIGS. 2A-C illustrate three types of template regions in reconstructed areas neighboring a current block for providing samples to derive the EIP filter.

FIG. 3 conceptually illustrates a diagonal order according to which an EIP filter is applied to generate the predictions for the current block.

FIG. 4 conceptually illustrates the spatial components of a convolutional filter.

FIG. 5 illustrates the pre-defined positions of spatial neighboring blocks, from which to inherit model parameters.

FIG. 6 conceptually illustrates inheriting temporal neighboring model parameters.

FIGS. 7A-B illustrate temporal candidate positions relative to the current block's position in a reference picture.

FIGS. 8A-B illustrate non-adjacent spatial neighboring blocks used to derive the spatial merge candidates relative to the current block.

FIGS. 9A-B conceptually illustrate current and reference regions being represented in history tables.

FIG. 10 illustrates the regions available for providing temporal candidates.

FIGS. 11A-D illustrate mapping non-adjacent spatial positions above the current CTU row for inheriting EIP information.

FIG. 12 illustrates an example video encoder that may implement EIP.

FIG. 13 illustrates portions of the video encoder that implement EIP information inheritance.

FIG. 14 conceptually illustrates a process for using inherited EIP model to encode a current block.

FIG. 15 illustrates an example video decoder that may implement EIP.

FIG. 16 illustrates portions of the video decoder that implement EIP information inheritance.

FIG. 17 conceptually illustrates a process for using inherited EIP model to decode a current block.

FIG. 18 conceptually illustrates an electronic system with which some embodiments of the present disclosure are implemented.

### DETAILED DESCRIPTION

In the following detailed description, numerous specific details are set forth by way of examples in order to provide a thorough understanding of the relevant teachings. Any variations, derivatives and/or extensions based on teachings described herein are within the protective scope of the present disclosure. In some instances, well-known methods, procedures, components, and/or circuitry pertaining to one or more example implementations disclosed herein may be described at a relatively high level without detail, in order to avoid unnecessarily obscuring aspects of teachings of the present disclosure.

### I. INTRA PREDICTION

a. Angular Intra Prediction

To capture the arbitrary edge directions presented in natural video, angular intra prediction directions are defined from 45 degrees to −135 degrees in clockwise direction. The number of directional intra modes can be 33 or 65, in addition to planar and DC modes. The directional intra prediction modes apply for all block sizes and for both luma and chroma intra predictions. The video coder may also maintain a list of most probable mode (MPM). To keep the complexity of the MPM list generation low, an intra mode coding method with 6 MPMs may be used by considering two available neighboring intra modes. The following three aspects are considered to construct the MPM list: Default intra modes, Neighboring intra modes, and Derived intra modes.

b. Wide-Angle Intra Prediction Modes

Several angular intra prediction modes may be adaptively replaced with wide-angle intra prediction modes for non-square blocks. The replaced modes can be signalled using the original mode indexes, which are remapped to the indexes of wide angular modes after parsing. The total number of intra prediction modes is still 67, and the intra mode coding method is unchanged.

c. Decoder Side Intra Mode Derivation (DIMD)

Decoder side intra mode derivation (DIMD) is an intra prediction coding tool in which two intra modes are derived from the reconstructed neighbor samples, and those two predictors are combined with the planar mode predictor with the weights derived from the gradients. The division operations in weight derivation are performed utilizing the same lookup table (LUT) based integerization scheme used by the cross-component linear model (CCLM). For example, the division operation in the orientation calculation

$$Orient = {G}_{y} / {G}_{x}$$

is computed by the following LUT-based scheme:

$$x = Floor ( Log 2 ( Gx ) )$$

$$normDiff = ( ( Gx ≪ 4 ) ≫ x ) \& 15$$

$$x += ( 3 + ( normDiff != 0 ) ? 1 : 0 )$$

$$Orient = ( Gy * ( DivSigTable [ normDiff ] \vert 8 ) + ( 1 ≪ ( x - 1 ) ) ) ≫ x$$

where

$$DivSigTable [ 16 ] = \{ 0 , 7 , 6 , 5 , 5 , 4 , 4 , 3 , 3 , 2 , 2 , 1 , 1 , 1 , 1 , 0 \} .$$

Derived intra modes are included into the primary list of intra most probable modes (MPM), so the DIMD process is performed before the MPM list is constructed. The primary derived intra mode of a DIMD block is stored with a block and is used for MPM list construction of the neighboring blocks.

The DIMD chroma mode uses the DIMD derivation method to derive the chroma intra prediction mode of the current block based on the neighboring reconstructed Y, Cb and Cr samples in the second neighboring row and column. Specifically, a horizontal gradient and a vertical gradient are calculated for each collocated reconstructed luma sample of the current chroma block, as well as the reconstructed Cb and Cr samples, to build a HoG. Then the intra prediction mode with the largest histogram amplitude values is used for performing chroma intra prediction of the current chroma block.

d. Template-Based Intra Mode Derivation (TIMD)

For each intra prediction mode in MPMs, The SATD between the prediction and reconstruction samples of the template is calculated. Normally, the left and above neighboring reconstructed samples are used as the template. First two intra prediction modes with the minimum SATD are selected as the TIMD modes. These two TIMD modes are fused with the weights after applying PDPC process, and such weighted intra prediction is used to code the current CU. Position dependent intra prediction combination (PDPC) is included in the derivation of the TIMD modes.

the TIMID intra prediction method derives predicted samples as a weighted combination of multiple predictors generated from different reference lines. In this process multiple intra predictors are generated and then fused by weighted averaging. The process of deriving the predictors to be used in the fusion process is described as follows:

For angular intra prediction modes including the single mode case of TIMD and DIMD, intra prediction is derived by weighting intra predictions obtained from multiple reference lines represented as p_{fusion}=w₀pₗᵢₙₑ+w₁pₗᵢₙₑ₊₁, where pₗᵢₙₑ is the intra prediction from the default reference line and pₗᵢₙₑ₊₁ is the prediction from the line above the default reference line. The weights are set as w₀=¾ and w₁=¼.

For TIMD mode with blending, pₗᵢₙₑ is used for the first mode (w₀=1, w₁=0) and pₗᵢₙₑ₊₁ is used for the second mode (w₀=0, w₁=1). For DIMD mode with blending, the number of predictors selected for a weighted average is increased from 3 to 6.

Intra prediction fusion method may be applied to luma blocks when angular intra mode has non-integer slope (required reference samples interpolation) and the block size is greater than 16. Intra prediction fusion may be used with MRL and not applied for ISP coded blocks.

e. Extrapolation Intra Prediction (or EIP)

Extrapolation Intra Prediction (or EIP) is an intra prediction mode that applies a linear model or filter to generate an intra-prediction of the current block, where the EIP linear model or filter is derived by using reconstructed pixels in an extended template region neighboring the current block. The extended template region extends beyond the edges of the current block by predefined lengths (or a predefined number of pixel positions.)

EIP is also termed as “multiple source sample-based prediction”. In some embodiments, EIP is restricted to the block size not greater than 32×32 and intra slice only. Similar to CCCM mode, an offset value is to be removed when feeding inputs to a EIP filter.

Under the EIP mode, an EIP filter or linear model is used to generate predictions for the current block based on the following calculation:

$${pred}_{( x , y )} = clip ( min , max , {\sum }_{i = 0}^{14} ( {c}_{i} \times ( {t}_{( x - xoffset , y - yoffset )} - offset ) ) + offset ) \qquad Eq . ( 1 )$$

where pred_{(x,y)} is the EIP predicted value of a sample at position (x, y) in the current block. cᵢ is the i^{th} coefficient of a derived EIP filter. For example, the derived EIP filter is a derived 15-tap EIP filter, each coefficient corresponds to one of 15 sample positions (x-xoffset, y-yoffset) near the current sample. The value (may be reconstructed or predicted sample) at each of the 15 sample positions used as input to the filter is represented by t_{(x_xoffset,y_yoffset)}. Offset values are applied to the inputs taps of the EIP filter, as well as at the output of the filter. To reduce the prediction error, “min” and “max” values (from the neighboring reconstructed area) are applied to restrict the output range of each predicted value. The top-left reconstructed pixel from a pre-defined neighboring area of the current block may be used as the offset value for EIP prediction. The “min” and “max” values may be obtained from reconstructed pixels in the pre-defined reconstructed area of the current block.

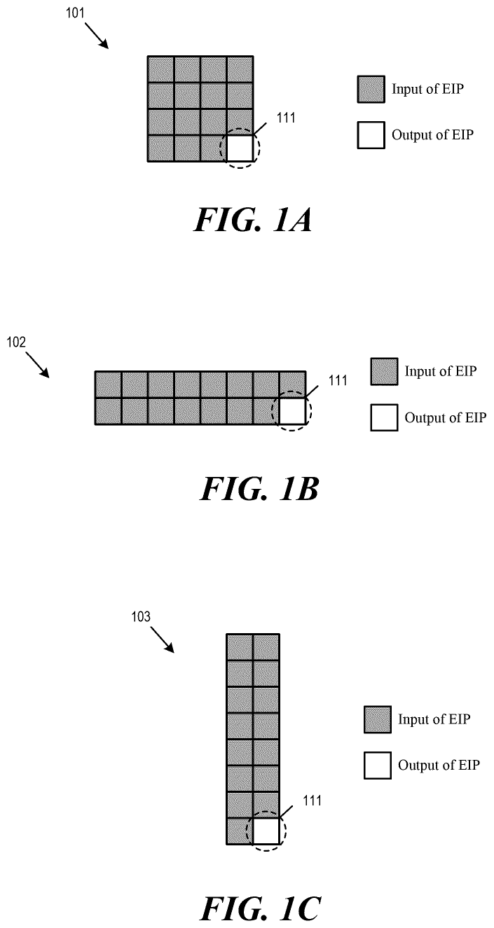

FIGS. 1A-C illustrate three types of filter kernels having fifteen inputs and generating one output that may be used by EIP. The three types of filter kernels are shown as groups of pixels in three different filter shapes. FIG. 1A illustrates a 4×4 square kernel 101. FIG. 1B illustrates an 8×2 rectangular kernel 102. FIG. 1C illustrates a 2×8 rectangular kernel 103. In each of the filter shapes, the one bottom-right sample position 111 is the output of the EIP filter, while the remaining 15 positions are used as the input of the EIP filter. The video coder may select one of the three EIP filter shapes for generating a prediction of the current block.

To derive EIP filter coefficients, sample positions in the selected filter shape moves or traverses in a reconstructed area with a one-pixel step to collect input samples and output samples. In some embodiments, the input and output samples are collected from the reconstructed area by having the selected filter shape traversing a defined template region in the reconstructed area.

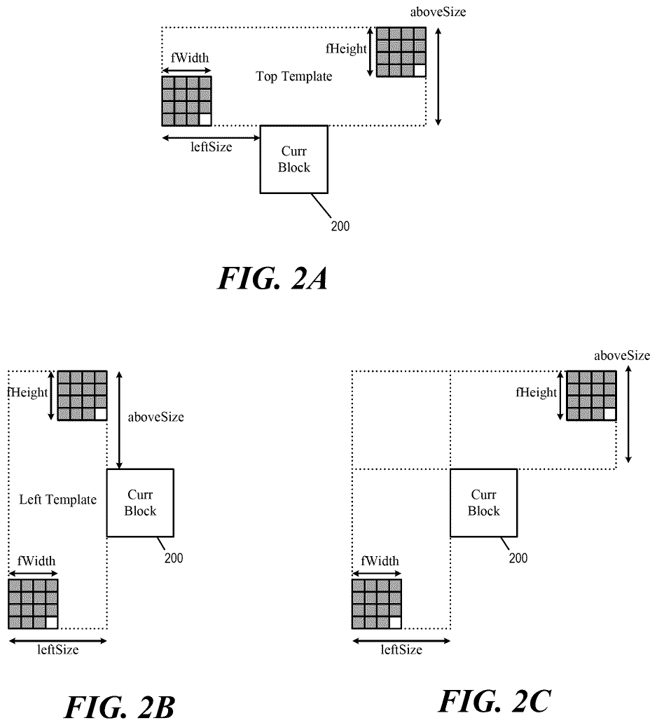

FIGS. 2A-C illustrate three types of template regions in reconstructed areas neighboring a current block 200 for providing samples to derive the EIP filter. The filter shape of FIG. 1A (4×4 square shaped) is used to illustrate the traversal of the template region for input and output samples. The size of reconstructed area depends on min (blockWidth, blockHeight) and the selected filter shape (fWidth, fHeight). For example, when the current block is an 8×16 block and the selected filter shape is 4×4, the aboveSize of reconstructed area is min(8, 16)+4−1=11, and the leftSize of reconstructed area is min(8, 16)+4−1=11.

FIG. 2A shows an EIP_T (or EIP_A) template region, which is a reconstructed area above the current block 200. The EIP_T template region extends beyond the left and right edges of the current block 200. For example, the EIP_T template region extends beyond the left edge of the current block 200 by leftSize and beyond the top edge of the current block 200 by aboveSize.

FIG. 2B shows an EIP_L template region, which is a reconstructed area left of the current block 200. The EIP_L template region extends beyond the top and bottom edges of the current block 200. For example, the EIP_L template region extends beyond the top edge of the current block 200 by aboveSize and left edge of the current block 200 by leftSize.

FIG. 2C shows an EIP_LT template region, which is a reconstructed area left and above the current block 200. The EIP_LT template region extend beyond top, right, left and bottom edges of the current block 200. For example, the EIP_LT template region extends beyond the top edge of the current block 200 by aboveSize and the left edge of the current block 200 by leftSize.

An auto-correlation matrix and cross-correlation vector are constructed while removing the offset value from the collected input samples and output samples. Then, the EIP coefficients are obtained or derived by the same method as in convolutional cross-component model (CCCM), which will be described in Section II.d below.

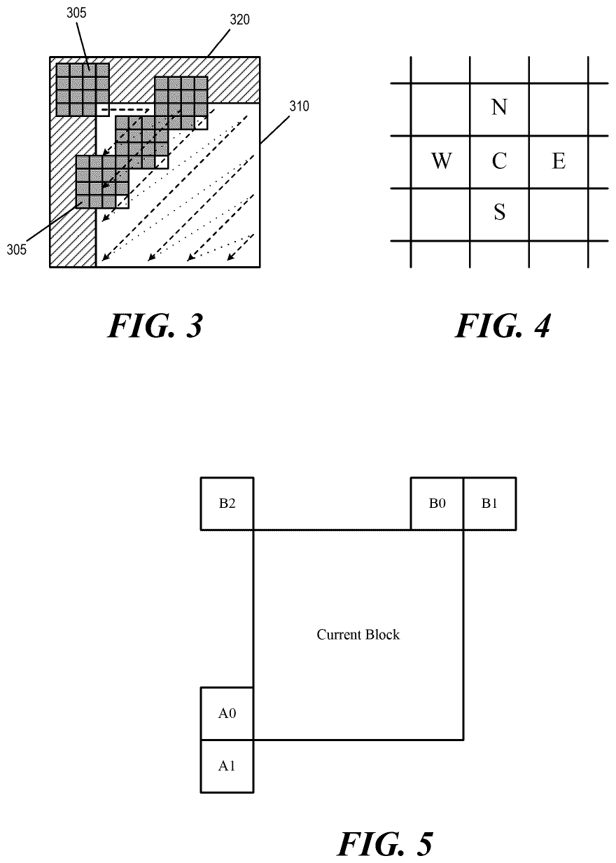

When applying the EIP model to generate the predictions for the current block, the EIP filter is applied from the top-left position to the bottom-right position by a diagonal prediction order. FIG. 3 conceptually illustrates a diagonal order according to which an EIP filter 305 is applied to generate the predictions for the current block. As illustrated, the EIP filter 305 traverses through the samples of the current block 310 to generate the predictor. The EIP filter 305 uses reconstructed samples in a region 320 neighboring the current block 310 and predicted samples within the current block 310 as inputs to the EIP filter 305.

EIP mode allows selection from three types of reconstructed areas to be used as templates for deriving the EIP model. EIP also allows selection from three types of filter kernel or filter shape. The three types of reconstructed areas as templates are shown in FIG. 2A-C above. The three types of filter kernel or filter shape are shown in FIGS. 1A-C above. In some embodiments, when the current block uses EIP mode for prediction, the encoder signals, and decoder receives, the relevant syntax elements to select a type of reconstructed area and a filter shape for the current block.

### II. CROSS-COMPONENT PREDICTION

a. Cross Component Linear Model (CCLM)

Cross Component Linear Model (CCLM) or Linear Model (LM) mode is a cross-component prediction mode in which chroma components of a block is predicted from the collocated reconstructed luma samples by linear models. The parameters (e.g., scale and offset) of the linear model are derived from already reconstructed luma and chroma samples that are adjacent to the block. The CCLM mode makes use of inter-channel dependencies to predict the chroma samples from reconstructed luma samples. This prediction is carried out using a linear model in the form of:

$$P ( i , j ) = α \cdot {rec}_{L}^{′} ( i , j ) + β \qquad eq . ( 1 )$$

P(i,j) in eq. (1) represents the predicted chroma samples in a CU (or the predicted chroma samples of the current CU) and rec′_{L} (i,j) represents the down-sampled reconstructed luma samples of the same CU (or the corresponding down-sampled reconstructed luma samples of the current CU).

The CCLM model parameters a (scaling parameter) and R (offset parameter) are derived based on at most four neighboring chroma samples and their corresponding down-sampled reconstructed luma samples. In LM_A mode (also denoted as LM_T mode), only the above or top-neighboring template is used to calculate the linear model coefficients. In LM_L mode (also denoted as LM_L mode), only left template is used to calculate the linear model coefficients. In LM_LA mode (also denoted as LM_LT mode), both left and above templates are used to calculate the linear model coefficients.

b. Multi-Model Linear Model (MMLM)

CCLM may be extended by adding three Multi-model LM (MMLM) modes. In each MMLM mode, the reconstructed neighboring samples are classified into two classes using a threshold which is the average of the luma reconstructed neighboring samples. The linear model of each class is derived using the Least-Mean-Square (LMS) method. For the CCLM mode, the LMS method is also used to derive the linear model. A slope adjustment to is applied to cross-component linear model (CCLM) and to Multi-model LM prediction. The adjustment is tilting the linear function which maps luma values to chroma values with respect to a center point determined by the average luma value of the reference samples.

c. Slope Adjustment of CCLM

CCLM uses a model with 2 parameters to map luma values to chroma values. The slope parameter “a” and the bias parameter “b” define the mapping as follows:

$$chromaVal = a * lumaVal + b$$

An adjustment “u” to the slope parameter is signaled to update the model to the following form:

$$chromaVal = {a}^{′} * lumaVal + {b}^{′}$$

where

$${a}^{′} = a + u$$

$${b}^{′} = b - u * {y}_{r} .$$

With this selection the mapping function is tilted or rotated around the point with luminance value yᵣ. The average of the reference luma samples used in the model creation as yᵣ in order to provide a meaningful modification to the model.

d. Convolutional Cross-Component Intra-Prediction Model (CCCM)

Convolutional cross-component model (CCCM) may applied to improve the cross-component prediction performance. For some embodiment, the convolutional model has 7-tap filter having a 5-tap plus sign shape spatial component, a non-linear term and a bias term. The input to the spatial 5-tap component of the filter includes a center (C) luma sample (which is collocated with the chroma sample to be predicted) and the center luma sample's above/north (N), below/south (S), left/west (W) and right/east (E) neighbors. FIG. 4 conceptually illustrates the spatial components of a convolutional filter. The nonlinear term (denoted as P) is represented as power of two of the center luma sample C and scaled to the sample value range of the content:

$$P = ( C * C + midVal ) ≫ bitDepth$$

Thus, for 10-bit content the non-linear term P is calculated as:

$$P = ( C * C + 5 \; 12 ) ≫ 10$$

The bias term (denoted as B) represents a scalar offset between the input and output (similarly to the offset term in CCLM) and is set to middle chroma value (512 for 10-bit content). Output of the filter is calculated as a convolution between the filter coefficients cᵢ and the input values and clipped to the range of valid chroma samples:

$$predChromaVal = {c}_{0} C + {c}_{1} N + {c}_{2} S + {c}_{3} E + {c}_{4} W + {c}_{5} P + {c}_{6} B$$

The filter coefficients cᵢ are calculated by minimising MSE between predicted and reconstructed chroma samples in the reference area. Whether to use 6 lines or 2 lines of neighbouring samples to derive the CCCM model parameters in the single model CCCM is determined by a template cost. Similarly, for the multi-model CCCM mode, the two candidates use 6 lines neighboring luma samples or luma samples collocated to the current chroma block to derive mean values which separate samples into two groups. The cost is derived by applying the candidate CCP (either 2 or 6 lines) on a template, calculating the sum of absolute difference (SAD) between CCP predicted samples and reconstructed samples in the template.

Reference area extends one PU width to the right and one PU height below the PU boundaries. Area is adjusted to include only available samples. The extensions to the area shown in blue are needed to support the “side samples” of the plus shaped spatial filter and are padded when in unavailable areas.

The MSE minimization is performed by calculating autocorrelation matrix for the luma input and a cross-correlation vector between the luma input and chroma output. Autocorrelation matrix is LDL decomposed and the final filter coefficients are calculated using back-substitution. The process follows roughly the calculation of the ALF filter coefficients in ECM, however LDL decomposition was chosen instead of Cholesky decomposition to avoid using square root operations.

CCCM may be applied to predict chroma samples from reconstructed luma samples in a similar way as done by the CCLM modes. As with CCLM, the reconstructed luma samples are down-sampled to match the lower resolution chroma grid when chroma sub-sampling is used. Similar to CCLM top, left or top and left reference samples are used as templates for model derivation.

Also, similarly to CCLM, there is an option of using a single model or multi-model variant of CCCM. The multi-model variant uses two models, one model derived for samples above the average luma reference value and another model for the rest of the samples (following the spirit of the CCLM design). Multi-model CCCM mode can be selected for PUs which have at least 128 reference samples available.

e. Gradient Linear Model

For YUV 4:2:0 color format, a gradient linear model (GLM) method can be used to predict the chroma samples from luma sample gradients. Two modes are supported: a two-parameter GLM mode and a three-parameter GLM mode.

Compared with the CCLM, instead of down-sampled luma values, the two-parameter GLM utilizes luma sample gradients to derive the linear model. Specifically, when the two-parameter GLM is applied, the input to the CCLM process, i.e., the down-sampled luma samples L, are replaced by luma sample gradients G.

$$C = α \cdot G + β$$

The other parts of the CCLM (e.g., parameter derivation, prediction sample linear transform) are kept unchanged. In the three-parameter GLM, a chroma sample can be predicted based on both the luma sample gradients and down-sampled luma values with different parameters:

$$C = {α}_{0} \cdot G + {α}_{1} \cdot L + {α}_{2} \cdot β$$

The model parameters of the three-parameter GLM are derived from 6 rows and columns adjacent samples by the LDL decomposition based MSE minimization method as used in the CCCM.

For signaling, when the CCLM mode is enabled to the current CU, one flag is signaled to indicate whether GLM is enabled for both Cb and Cr components; if the GLM is enabled, another flag is signaled to indicate which of the two GLM modes is selected and one syntax element is further signaled to select one of 4 gradient filters for the gradient calculation.

f. Cross-Component Prediction (CCP) merge

In some embodiments, for chroma coding, a flag is signaled to indicate whether CCP mode (including CCLM, CCCM, GLM and their variants) or non-CCP mode (conventional chroma intra prediction mode, fusion of chroma intra prediction mode) is used. If the CCP mode is selected, one more flag is signaled to indicate how to derive the CCP type and parameters, i.e., either from a CCP merge list or signaled/derived on-the-fly. a CCP merge candidate list is constructed from the spatial adjacent, spatial non-adjacent, or history-based candidates. After including these candidates, default models are further included to fill the remaining empty positions in the merge list. In order to remove redundant CCP models in the list, pruning operation is applied. After constructing the list, the CCP models in the list are reordered depending on the SAD costs, which are obtained using the neighboring template of the current block.

In some embodiments, the inherited model parameters can be from a block that is an immediate neighboring block. The models from blocks at pre-defined positions are added into a CCP merge candidate list in a pre-defined order.

In some embodiments, the pre-defined positions and the pre-defined order can be the same as those of spatial candidates for inter merge mode. FIG. 5 illustrates the pre-defined positions of spatial neighboring blocks, from which to inherit model parameters. The pre-defined order can be B₀, A₀, B₁, A₁ and B₂ as their respective model parameters are added to the CCP merge candidate list.

In some embodiments, a history-based table is maintained to include the recently used CCP models, and the table is reset at the beginning of each CTU row. If the current list is not full after including spatial adjacent and non-adjacent candidates, the CCP models in the history-based table are added into the list as history-based candidates.

In some embodiments, CCLM candidates with default scaling parameters are considered as default candidates, but only when the list is not full after including the spatial adjacent, spatial non-adjacent, or history-based candidates. If the current list has no candidates with the single model CCLM mode, the default scaling parameters are {0, ⅛, −⅛, 2/8, − 2/8, ⅜, −⅜, 4/8, − 4/8, ⅝, −⅝, 6/8}. Otherwise, the default scaling parameters are {0, the scaling parameter of the first CCLM candidate+{⅛, −⅛, 2/8, − 2/8, ⅜, −⅜, 4/8, − 4/8, ⅝, −⅝, 6/8}}. The offset parameter is derived according to the default scaling parameter, average neighboring reconstructed luma sample value, and average neighboring reconstructed Cb/Cr sample value.

In some embodiments, a flag is signaled to indicate whether the CCP merge mode is applied or not. If CCP merge mode is applied, an index is signaled to indicate which candidate model is used by the current block. In addition, CCP merge mode is not allowed for the current chroma coding block when the current CU is coded by intra sub-partitions (ISP) with single tree, or the current chroma coding block size is less than or equal to 16.

### III. EIP MODEL INHERITANCE

a. Inherit EIP Information

In some embodiments, an EIP model of a previous block, e.g., an EIP that is derived based on template samples of the previous block, can be inherited and used for intra-predictive coding by a subsequent block. In some embodiments, all or part of the EIP information of inherited EIP model could be stored together with the inherited EIP model parameters (e.g., coefficients, offsets, max, min). The EIP information may include model derivation information such as, but not limited to: template region selection type (e.g., select from EIP_T, EIP_L, and EIP_LT), size of template region, kernel type (e.g., 4×4 square kernel, 8×2 rectangular kernel or 2×8 rectangular kernel), multi-model flag, classification method for multi-model, threshold for multi-model, fusion flag, fusion method, post-filtering flag or model parameters.

b. Refinement of Inherited EIP Model Parameters

In some embodiments, the parameters of inherited model may be further refined based on the inherited EIP information. The inherited EIP information may include how the inherited model is derived, such as the template region selection type and/or the size of template region. The refined parameters are derived based on local information. The refinement process may follow how the inherited model was derived and use the same type of template and/or the same size of template region.

In some embodiments, the parameters of the inherited model may be further refined based on a pre-defined process. A pre-defined template type and a pre-defined size of template region are used for all types of inherited EIP model.

c. Inherit Spatial Neighboring Model Parameters

In some embodiments, the inherited EIP model parameters may be from a block that is an immediate neighboring block. The models from blocks at pre-defined positions are added into the candidate list in a pre-defined order. For example, the pre-defined positions may be the positions as illustrated in the FIG. 5, and the pre-defined order may be B₀, A₀, B₁, A₁ and B₂, or A₀, B₀, B₁, A₁ and B₂.

In some embodiments, the pre-defined positions include the positions at the immediate above (W>>1) or ((W>>1)−1) position if W is greater than or equal to TH, and the positions at the immediate left (H>>1) or ((H>>1)−1) position if H≥TH, where W and H are the width and height of the current block, TH is a threshold value which may be 4, 8, 16, 32, or 64.

In some embodiments, the maximum number of inherited models from spatial neighbors are smaller than the number of pre-defined positions. For example, if there are 5 pre-defined positions and the pre-defined order is B₀, A₀, B₁, A₁ and B₂, and the maximum number of inherited models from spatial neighbors is 4, the model from B₂ is added into the candidate list only when one of preceding blocks is not available or is not coded in EIP model.

d. Inherit Temporal Neighboring Model Parameters

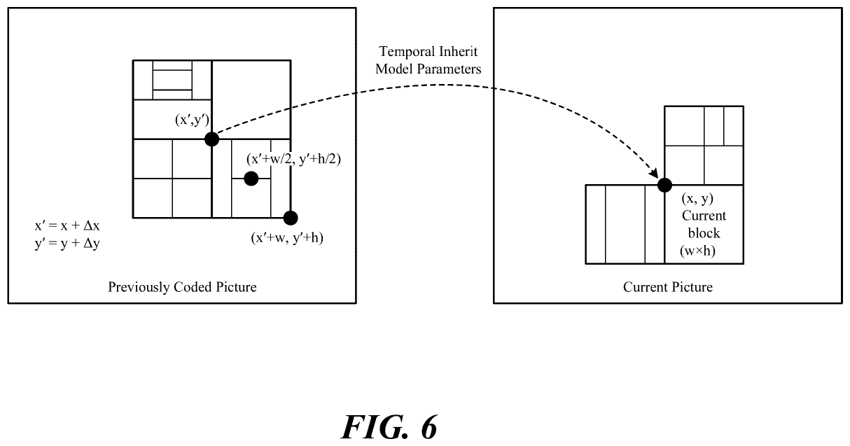

In some embodiments, if the current slice/picture is a non-intra slice/picture, the inherited model parameters may be from the block in the previous coded slices/pictures. FIG. 6 conceptually illustrates inheriting temporal neighboring model parameters. As illustrated, the current block position is at (x, y) and the block size is w×h. The inherited model parameters may be from a block at position (x′, y′), (x′, y′+h/2), (x′+w/2, y′), (x′+w/2, y′+h/2), (x′+w, y′), (x′, y′+h), or (x′+w, y′+h) of the previous coded slices/picture, where x′=x+Δx and y′=y+Δy.

In some embodiments, if the prediction mode of the current block is intra, Ax and Ay are set to 0. If the prediction mode of the current block is inter, Ax and Ay are set to the horizontal and vertical motion vector of the current block. In some embodiments, if the current block is inter bi-prediction, Δx and Δy are set to the horizontal and vertical motion vector in reference picture list 0. In still another embodiment, if the current block is inter bi-prediction, Δx and Δy are set to the horizontal and vertical motion vector in reference picture list 1.

For still another embodiment, if the current block is inter bi-prediction, the inherited model parameters may be from the block in the previous coded slices/pictures in the reference lists. For example, if the horizontal and vertical motion vector in reference picture list 0 is Δx_{L0} and Δy_{L0}, the motion vector could be scaled to other reference pictures in the reference list 0 and 1. If the motion vector is scaled to the i-th reference picture in the reference list 0 as (Δx_{L0,i0}, Δy_{L0,i0}). The model could be from the block in the i^{th} reference picture in the reference list 0, and Δx and Δy are set to (Δx_{L0,i0}, Δy_{L0,i0}). For example, if the horizontal and vertical motion vector in reference picture list 0 is Δ_{L0,i1}, and Δy_{L0}, the motion vector is scaled to the i-th reference picture in the reference list 1 as (Δx_{L0,i1}, Δy_{L0,i1}). The model may be from the block in the i-th reference picture in the reference list 1, and Δx and Δy are set to (Δx_{L0,i1}, Δy_{L0,i1}).

In some embodiments, if the current slice/picture is a non-intra slice/picture, the inherited model parameters could be from the block in the previous coded slices/pictures. In some embodiments, the current block position is at (x, y) and the block size is w×h. The two value sets αₓ and α_{y} are defined as:

$${α}_{x} = \{ {α}_{x 1} , {α}_{x 2} , {α}_{x 3} , … , {α}_{xn} \} , {α}_{xi} < {α}_{xj} if i < j$$

$${α}_{y} = \{ {α}_{y 1} , {α}_{y 2} , {α}_{y 3} , … , {α}_{yn} \} , {α}_{yi} < {α}_{yj} if i < j$$

All values in αₓ and αy are positive numbers. Let

$$( {x}_{mid} , {y}_{mid} ) = ( x + \frac{w}{2} , y + \frac{h}{2} ) .$$

The inherited model parameters could be from the block at positions (x_{mid}+αₓᵢ×w, y_{mid}+α_{yi}×h), (x_{mid}+αₓᵢ×w, y_{mid}−α_{yi}×h), (x_{mid}−αₓᵢ×w, y_{mid}+α_{yi}×h), (x_{mid}−αₓᵢ×w, y_{mid}−α_{yi}×h), (x_{mid}+αₓᵢ×w, 0), (x_{mid}−αₓᵢ×w, 0), (0,y_{mid}+α_{yi}×h), (0,y_{mid}−α_{yi}×h) of the previous coded slices/picture.

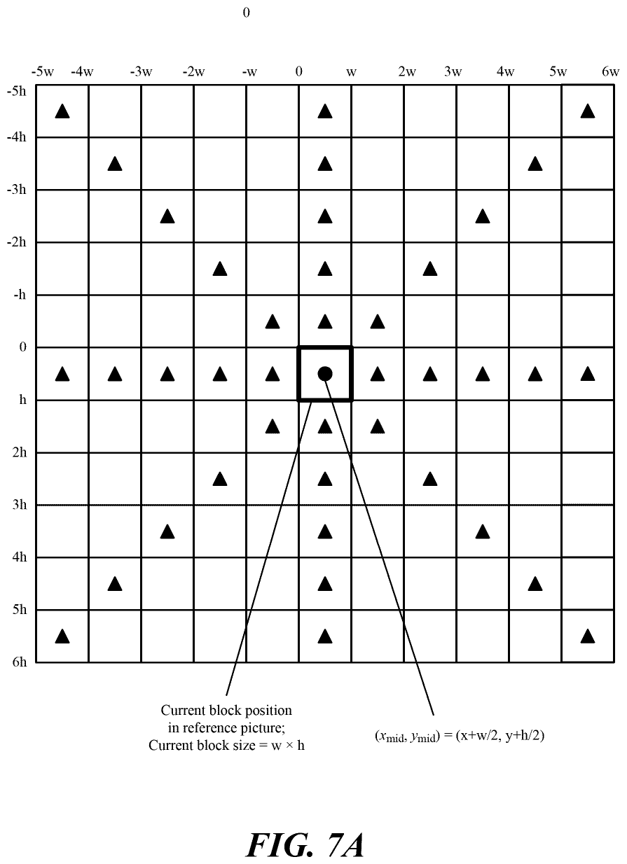

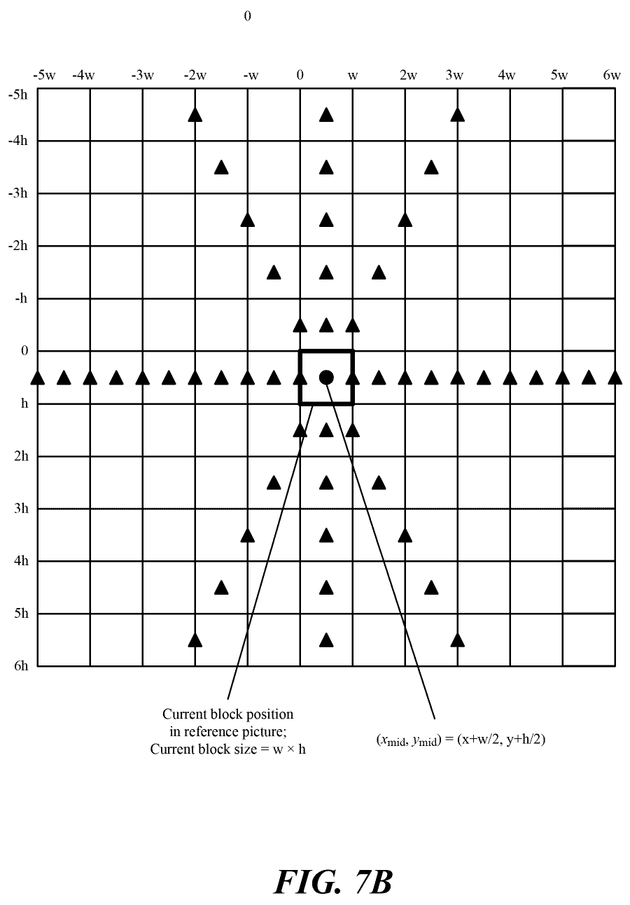

In some embodiments, αₓ=α_{y}. For example, αₓ=α_{y}={1, 2, 3, 4, 5}. The inherited model parameters may be from a block of the previous coded slices/picture at positions depicted in FIG. 7A, which illustrates temporal candidate positions that are in the middle of blocks of a reference picture. The figure shows the position of the current block (not the current block itself) in the reference picture.

In some embodiments, αₓ≠α_{y}. For example,

$${α}_{x} = \{ \frac{1}{2} , 1 , \frac{3}{2} , 2 , \frac{5}{2} \}$$

and α_{y}={1, 2, 3, 4, 5}. The inherited model parameters may be from a block of the previous coded slices/picture at positions depicted in FIG. 7B, which illustrates alternate temporal candidate positions that are denser in the x-direction than in the y-direction.

In some embodiments, the current block position is at (x, y) and the block size is w×h. The inherited model parameters could be from the block at positions (x+αₓᵢ×w, y+α_{yi}×h), (x+αₓᵢ×w, y−α_{yi}×h), (x−αₓᵢ×w, y+α_{yi}×h), (x−αₓᵢ×w, y−α_{yi}×h), (x+αₓᵢ×w, 0), (x−αₓᵢ×w, 0), (0, y+α_{yi}×h), (0, y−α_{yi}×h) of the previous coded slices/picture.

In some embodiments, the models from the positions closer to (x_{mid}, y_{mid}) are added into the final merge candidate list first. In some embodiments, the models from the positions closer to (x, y) are added into the final merge candidate list first.

In some embodiments, let δx and δy be two fixed positive numbers. The inherited model parameters may be from positions (x_{mid}+αₓᵢ×(x_{mid}+αₓᵢ×δx, y_{mid}+α_{yi}×δy), (x_{mid}+αₓᵢ×δx, y_{mid}−α_{yi}×δy), (x_{mid}−αₓᵢ×δx, y_{mid}+α_{yi}×δy), (x_{mid}−αₓᵢ×δx, y_{mid}−α_{yi}×δy), (x_{mid}+αₓᵢ×δx, 0), (x_{mid}−αₓᵢ×δx, 0), (0, y_{mid}+α_{yi}×δy), (0, y_{mid}−α_{yi}×δy) of a block of the previous coded slices/picture the block.

In some embodiments, the current block position is at (x, y) and the block size is w×h. Let δx and δy be two fixed positive numbers The inherited model parameters may be at positions (x+αₓᵢ×δx, y+α_{yi}×δy), (x+αₓᵢ×δx, y−α_{yi}×δy), (x−αₓᵢ×δx, y+α_{yi}×δy), (x−αₓᵢ×δx, y−α_{yi}×δy), (x+αₓᵢ×δx, 0), (x−αₓᵢ×δx, 0), (0, y+α_{yi}×δy), (0, y−α_{yi}×δy) of a block of the previous coded slices/picture.

In some embodiments, the current block position is at (x, y) and the block size is w×h. The inherited model parameters could be from the block at some pre-defined positions (x′, y′) of the previous coded slices/picture. For one example, the positions are inside the corresponding area of the current encoding block, i.e., x≤x′<x+w and y≤y′<y+h. The inherited model parameters could be from the block at positions

$$( x , y ) , ( x + w - 1 , y ) , ( x , y + h - 1 ) , ( x + w - 1 , y + h - 1 ) , ( x + \frac{w}{2} , y + \frac{h}{2} ) .$$

For another example, the positions are outside of the corresponding area of the current encoding block, i.e., x′<x+ or x′≥x+w, and y′<y or y′≥y+h. The inherited model parameters could be from the block at (x−1, y), (x, y−1), (x−1, y−1), (x+w, y), (x+w−1, y−1), (x+w, y−1), (x, y+h), (x−1, y+h−1), (x−1, y+h), (x+w, y+h−1), (x+w−1, y+h), (x+w, y+h)

In some embodiment, the previous coded picture the inherited parameter model is from, i.e., the collocated picture, is one of the pictures in the reference lists. In some embodiments, the collocated picture is signaled in the picture/slice header. The reference list and the reference index are signaled in the picture/slice header. For example, the collocated picture is selected as L0[0]. For another example, the collocated picture is selected as L1[0].

In some embodiments, the collocated picture is selected as the picture in the reference lists whose picture order count (POC) difference between it and the current picture is the smallest. For example, if the POC of current picture is 8, the POCs of pictures in reference list 0 are {7, 6, 5, 0} and POCs of pictures in reference list 1 are {7, 6, 5, 4}, then L0[0](equivalent to L1[0]) is selected since its POC difference is the smallest. In some embodiments, if there are two pictures whose respective POC differences with the current picture are both the smallest, the picture with the smaller POC is selected. For example, if the POC of current picture is 2, the POCs of pictures in reference list 0 are {0, 4, 8} and POCs of pictures in reference list 1 are {8, 16, 32}, then L0[0](POC=0) is selected.

In some embodiment, if there are two pictures whose respective POC differences with the current picture are both the smallest, the picture with the larger POC is selected. For example, if the POC of current picture is 2, the POCs of pictures in reference list 0 are {0, 4, 8} and POCs of pictures in reference list 1 are {8, 16, 32}, then L0[1](POC=4) is selected. In some embodiments, if there are two pictures whose respective POC differences with the current pictures are both the smallest, the picture with smaller QP difference between it and the current picture is selected. For example, if the POC of current picture is 2, and the QP of current picture is 28. The POCs and QPs of the pictures in reference list 0 are {0, 4, 8} and {19, 26, 23}. The POCs and QPs of the pictures in reference list 1 are {8, 16, 32} and {23, 22, 21}. Then L0[1](POC=4 and QP=26) is selected. In some embodiments, if there are two pictures whose respective POC differences with the current picture are both the smallest, the picture with the smaller QP is selected. In some embodiments, if there are two pictures whose respective POC differences with the current picture are both the smallest, the picture with the larger QP is selected.

In some embodiments, the collocated picture is selected as the picture in the reference lists whose QP difference between it and the current picture is the smallest. For example, if the QP of current picture is 28, and the QPs of the pictures in reference list 0 are {19, 26, 23} and the QPs of the pictures in reference list 1 are {23, 22, 21}. Then L0[1] is selected. In some embodiments, if there are more than one pictures in the reference lists whose respective QP differences with the current picture are the smallest, the picture with the smaller QP is selected. In some embodiments, if there are more than one pictures whose respective QP differences with the current picture are the smallest, the picture with the larger QP is selected. In some embodiments, if there are more than one pictures whose respective QP differences with the current picture are the smallest, the picture with the smaller POC distance is selected.

In some embodiments, the collocated picture is selected as the picture in the reference lists whose QP is the smallest. In some embodiments, the collocated picture is selected as the picture in the reference lists whose QP is the largest. In some embodiments, the previous coded picture the inherited parameter model is from, i.e., the collocated picture, is the most recently coded I-picture. The EIP model information of the most recently coded I-slice/picture is stored in a long-term reference buffer.

In some embodiments, the collocated picture and the position where the inherited parameter model is from is determined by the motion vector of a neighboring block. For example, if the current block position is at (x, y) and the block size is w×h. The inherited model parameters could be from the block at position (x′, y′), (x′, y′+h/2), (x′+w/2, y′), (x′+w/2, y′+h/2), (x′+w, y′), (x′, y′+h), or (x′+w, y′+h) of the collocated picture, where x′=x+Δx and y′=y+Δy. Δx and Δy are set to the L0 horizontal and vertical motion vector of the neighboring block, and the collocated picture is the L0 reference picture indicated by the L0 motion vector of the neighboring block. In still another embodiment, if the neighboring block is inter bi-prediction, Δx and Δy are set to the L1 horizontal and vertical motion vector of the neighboring block, and the collocated picture is the L1 reference picture indicated by the L1 motion vector of the neighboring block. In one embodiment, the neighboring block is the left block of the current block. In another embodiment, the neighboring block is the above block of the current block.

In some embodiment, the positions in the previous coded slices/pictures where the inherited parameter model is from is determined by the motion vector of a neighboring block. Let Δx and Δy be the horizontal and vertical displacement determined based on the selected motion vector of the neighboring block, the current block position is at (x, y) and the block size is w×h. The inherited model parameters could be from the block at position (x′, y′), where x′=x+Δx and y′=y+Δy, or where x′=x+w/2+Δx and y′=y+h/2+Δy.

In some embodiments, the inherited model parameters could also be from the block positions in the patterns described above. The positions are centered at (x′, y′). For example, let the current block size be w×h. The two value sets αₓ and α_{y} are defined as:

$${α}_{x} = \{ {α}_{x 1} , {α}_{x 2} , {α}_{x 3} , … , {α}_{xn} \} , {α}_{xi} < {α}_{xj} if i < j$$

$${α}_{y} = \{ {α}_{y 1} , {α}_{y 2} , {α}_{y 3} , … , {α}_{yn} \} , {α}_{yi} < {α}_{yj} if i < j$$

All values in αₓ and α_{y} are positive numbers. The inherited model parameters may be from a block of the previous coded slices/picture at positions (x′+αₓᵢ×w, y′+α_{yi}×h), (x′+αₓᵢ×w, y′−α_{yi}×h), (x′−αₓᵢ×w, y′+α_{yi}×h), (x′−αₓᵢ×w, y′−α_{yi}×h), (x′+αₓᵢ×w, 0), (x′−αₓᵢ×w, 0), (0, y′+α_{yi}×h), (0, y′−α_{yi}×h). For another example, let δx and δy be two fixed positive numbers. The inherited model parameters may be from a block of the previous coded slices/picture at positions (x′+αₓᵢ×δx, y′+α_{yi}×δy), (x′+αₓᵢ×δx, y′−α_{yi}×δy), (x′−αₓᵢ×δx, y′+α_{yi}×δy), (x′−αₓᵢ×δx, y′−α_{yi}×δy), (x′+αₓᵢ×δx, 0), (x′−αₓᵢ×δx, 0), (0, y′+α_{yi}×δy), (0, y′−α_{yi}×δy).

For another example, the inherited model parameters could be from the block at some pre-defined positions relative to (x′, y′) of the previous coded slices/picture. The positions could be

$$( {x}^{′} , {y}^{′} ) , ( {x}^{′} + w - 1 , {y}^{′} ) , ( {x}^{′} , {y}^{′} + h - 1 ) ,$$

$$( {x}^{′} + w - 1 , {y}^{′} + h - 1 ) , ( {x}^{′} + \frac{w}{2} , {y}^{′} + \frac{h}{2} ) .$$

For another example, the positions may be (x′−1, y′), (x′, y′−1), (x′−1, y′−1), (x′+w, y′), (x′+w−1, y′−1), (x′+w, y′−1), (x′, y′+h), (x′−1, y′+h−1), (x′−1, y′+h), (x′+w, y′+h−1), (x′+w−1, y′+h), (x′+w, y′+h)

In some embodiments, the neighboring block may be at a pre-defined position. For example, the pre-defined position may be A₀, or A₁, or B₀, or B₁, or B₂ (as described by reference to FIG. 5 above). If the block at the pre-defined position is not an inter block, no neighboring block is selected.

In some embodiments, when selecting the neighboring block, there is a list of pre-defined positions according to a checking order, and the positions may be the spatial position described in Section III.c above. The selected neighboring block may be the first position in the list that is an inter block. The L0 motion vector is selected. If the L0 motion vector is not available, select the L1 motion vector. For another example, the L1 motion vector is selected. If the L1 motion vector is not available, select the L0 motion vector.

For another example, the positions in the list are checked in the pre-defined checking order. For each position, the L0 motion vector is first checked, and then the L1 motion vector. For another example, the L1 motion vector is first checked, and then the L0 motion vector. The selected motion vector is the first whose reference picture is the collocated picture.

In some embodiments, the horizontal and vertical displacement Δx and Δy are determined based on the selected motion vector of the neighboring block. For example, if the reference picture of the selected motion vector and the collocated picture are the same picture, Δx equals to the horizonal part of the selected motion vector and Δy equals to the vertical part of the selected motion vector. If the horizonal part or the vertical part of the selected motion vector is fractional, Δx equals to the horizonal part of the selected motion vector after rounding and Δy equals to the vertical part of the selected motion vector after rounding. The rounding method used may be but not limited to the following methods: rounding toward negative infinity, rounding toward positive infinity, rounding toward zero, or rounding to the nearest integer (e.g., rounding away from zero, rounding half up, rounding half down, . . . ).

For another example, if the reference picture of the selected motion vector and the collocated picture are not the same. The reference picture may be one of the pictures in the reference list, while the collocated picture is signaled in the picture/slice header. Let the POC distance between the current picture and the reference picture of the selected motion vector be tb, and the POC distance between the current picture and the collocated picture be td, the selected motion vector be (mv_x, mv_y). Δx=mv_x*(td/tb) and Δy=mv_y*(td/tb). If mv_x*(td/tb) or mv_y*(td/tb) is fractional, Δx equals to the horizonal part of the selected motion vector after rounding and Δy equals to the vertical part of the selected motion vector after rounding. The rounding method used could be but not limited to the following methods: rounding toward negative infinity, rounding toward positive infinity, rounding toward zero, or rounding to the nearest integer (e.g., rounding away from zero, rounding half up, rounding half down, . . . ).

In some embodiments, the inherited model parameters are derived by using the reconstruction samples of the collocated block. Let the current block position be at (x, y) and the block size w×h. The collocated block is a block positioned at (x′, y′) in the collocated picture with block size w×h, when the inherited model is from position (x′, y′). For another example, the collocated block could be a block positioned at (x′, y′) in the collocated picture with block size m×n, where m and n are fixed positive values. For example, the collocated block could be at (x, y). For another example, if Δx and Δy are the L0 horizontal and vertical motion vector of the neighboring block, and the collocated picture is the L0 reference picture indicated by the L0 motion vector of the neighboring block, the collocated block could be at (x+Δx, y+Δy) in the collocated picture. (x′, y′) may be the block positions in the patterns described in earlier paragraphs. For example, (x′, y′) may be (x+αₓᵢ×w, y+α_{yi}×h), (x+αₓᵢ×w, y−α_{yi}×h), (x−αₓᵢ×w, y+α_{yi}×h), (x−αₓᵢ×w, y−α_{yi}×h), (x+αₓᵢ×w, 0), (x−αₓᵢ×w, 0), (0, y+α_{yi}×h), (0, y−α_{yi}×h).

In some embodiment, the model may be inherited from more than one previous coded pictures. The model parameter could be inherited from any picture in a picture set, which contains N previous coded pictures. An index could be signaled in or parsed from the bitstream to indicate the selected picture. The index ranges from 0 to N−1. In some embodiments, the picture whose POC difference with the current picture is smaller is associated with the smaller index. In some embodiments, the picture whose QP difference with the current picture is smaller is associated with the smaller index. In some embodiments, the picture whose QP is smaller is associated with the smaller index. In some embodiments, the picture whose QP is larger is associated with the smaller index.

e. Inherit Non-Adjacent Spatial Neighboring Models

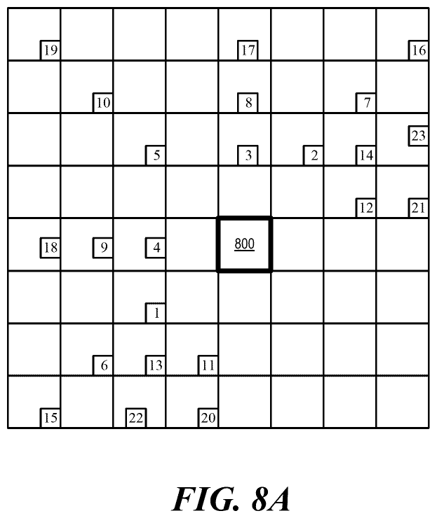

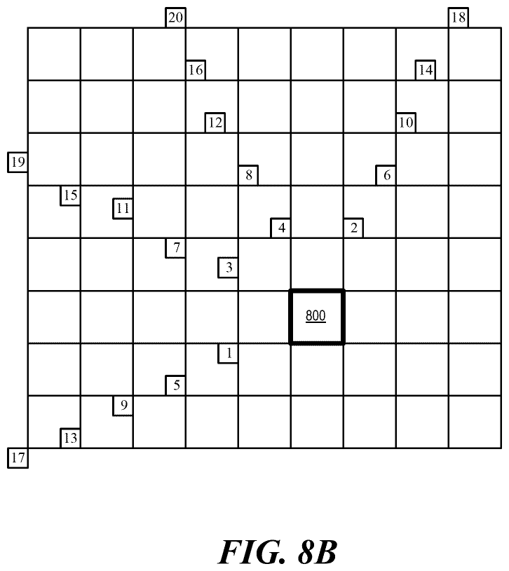

In some embodiments, the inherited model parameters may be from blocks that are spatial neighboring blocks. The models from blocks at pre-defined positions are added into the candidate list in a pre-defined order. For example, the pattern of the positions and order may be as the pattern depicted in FIGS. 8A-B, which illustrate non-adjacent spatial neighboring blocks used to derive the spatial merge candidates relative to the current block. FIG. 8A and FIG. 8B also show, for a current block 800, two different search patterns for pre-defined positions in non-adjacent spatial neighbors from which to inherit models.

In the examples of FIGS. 8A-B, the distances between any two neighboring positions are equal to the width or the height of the current block. In some other embodiments, the distances between the positions that are closer to the current block may be smaller than the positions that are further away from the current block. In some other embodiments, the distance between the positions that are closer to the current block may be larger than the positions that are further away from the current block.

For some embodiments, the maximum number of inherited models from non-adjacent spatial neighbors are smaller than the number of pre-defined positions. If the maximum number of inherited models from non-adjacent spatial neighbors is N, the search pattern 2 is used only when the number of available models from search pattern 1 is smaller than N.

In some embodiments, let the current block position be (x, y) and the block size be w×h. The two value sets αₓ and α_{y} are defined as:

$${α}_{x} = \{ {α}_{x 1} , {α}_{x 2} , {α}_{x 3} , … , {α}_{xn} \} , {α}_{xi} < {α}_{xj} if i < j$$

$${α}_{y} = \{ {α}_{y 1} , {α}_{y 2} , {α}_{y 3} , … , {α}_{yn} \} , {α}_{yi} < {α}_{yj} if i < j$$

All values in αₓ and α_{y} are positive numbers. Let x′=x+Δx and y′=y+Δy. The inherited model parameters could be from the positions determined by x′ and y′. For example, the inherited model parameters could be from the block at positions (x′+αₓᵢ×w, y′+α_{yi}×h), (x′+αₓᵢ×w, y′−α_{yi}×h), (x′−αₓᵢ×w, y′+α_{yi}×h), (x′−αₓᵢ×w, y′−α_{yi}×h), (x′+αₓᵢ×w, 0), (x′−αₓᵢ×w, 0), (0, y′+α_{yi}×h), (0, y′−α_{yi}×h). For another example, let δx and δy be two fixed positive numbers. The inherited model parameters may be from the block at positions (x′+αₓᵢ×δx, y′+α_{yi}×δy), (x′+αₓᵢ×δx, y′−α_{yi}×δy), (x′−αₓᵢ×δx, y′+α_{yi}×δy), (x′−αₓᵢ×δx, y′−α_{yi}×δy), (x′+αₓᵢ×δx, 0), (x′−αₓᵢ×δx, 0), (0, y′+α_{yi}×δy), (0, y′−α_{yi}×δy). For another example, the inherited model parameters may be from the block at some pre-defined positions relative to (x′, y′) of the previous coded slices/picture. The positions could be

$$( {x}^{′} , {y}^{′} ) , ( {x}^{′} + w - 1 , {y}^{′} ) , ( {x}^{′} , {y}^{′} + h - 1 ) ,$$

$$( {x}^{′} + w - 1 , {y}^{′} + h - 1 ) , ( {x}^{′} + \frac{w}{2} , {y}^{′} + \frac{h}{2} ) .$$

For another example, the positions may be (x′−1, y′), (x′, y′−1), (x′−1, y′−1), (x′+w, y′), (x′+w−1, y′−1), (x′+w, y′−1), (x′, y′+h), (x′−1, y′+h−1), (x′−1, y′+h), (x′+w, y′+h−1), (x′+w−1, y′+h), (x′+w, y′+h). For another example, the position could be (x′, y′), (x′, y′+h/2), (x′+w/2, y′), (x′+w/2, y′+h/2), (x′+w, y′), (x′, y′+h), or (x′+w, y′+h).

In some embodiments, Δx and Δy could be set according to the horizontal and vertical block vector of a neighboring block. For example, Δx and Δy may be equal to the horizontal and vertical block vector of a neighboring block.

f. Inherit Model Parameters from History Table

In some embodiments, the inherited model parameters may be from a EIP model history table. The models in the history table may be added into the candidate list according to a pre-defined order. In some embodiments, the adding order of historical candidate may be from the beginning of the table to the end of the table. In some embodiments, the adding order of historical candidate may be from a certain pre-defined position to the end of the table. In some embodiments, the adding order of historical candidate may be from the end of the table to the beginning of the table. In some embodiments, the adding order of historical candidate may be from a certain pre-defined position to the beginning of the table. In some embodiments, the adding order of historical candidate may be in an interleaved manner (e.g., the first added candidate is from the beginning of the table, the second added candidate is from the end of the table and so on).

In some embodiments, single EIP model history table could be maintained for storing the previous EIP model, and the history table could be reset at the start of the current picture, current slice, current tile, every M CTU rows or every N CTUs, N and M could be any value greater than 0. In some embodiments, the EIP model history table may be reset at the end of the current picture, current slice, current tile, current CTU row or current CTU.

In some embodiments, one picture could be divided into several regions, and for each region, a history table is kept. The history table 0 and one additional history table will be updated during the encoding/decoding process. The additional history table could be determined by the current position. For example, if the current CU locates in the second region, the additional history table to be updated is history table 2.

In some embodiments, multiple history tables are used for different updated frequency. For example, the first history table is updated every CU, the second history table is updated every two CUs, the third history table is updated every four CUs and so on.

In some embodiments, multiple history tables are used for storing different type of EIP model. For example, the first history table is used for storing single model, and the second history table is used for storing multi-model.

In some embodiments, multiple history tables are used for different intensity of reconstructed sample. For example, if the average of the reconstructed samples intensity in the neighboring of current block are greater than a pre-defined threshold, the EIP model will be stored in the first history table; otherwise, the EIP model will be store in the second history table.

In some embodiments, when adding historical candidates from multiple history tables to the candidate list, the adding order could be from the beginning of the certain table to the end of the certain table, and then add the next history table in the same order or in a reversed order. In some embodiments, the adding order may be from the end of the certain table to the beginning of the certain table, and then add the next history table in the same order or in a reversed order. In some embodiments, the adding order could be from the certain pre-defined position of the certain table to the end of the certain table, and then add the next history table in the same order or in a reversed order. In some embodiments, the adding order may be from the certain pre-defined position of the certain table to the beginning of the certain table, and then add the next history table in the same order or in a reversed order. In some embodiments, the adding order of historical candidate may be in an interleaved manner in a certain history table (e.g., the first added candidate is from the beginning of the certain history table, the second added candidate is from the end of the certain history table and so on), and then add the next history table in the same order or in a reversed order.

In some embodiments, the adding order could be from the beginning of each history table to the end of each history table. In some embodiments, the adding order could be from the end of each history table to the beginning of each history table. In some embodiments, the adding order could be from the certain pre-defined position of each history table to the end of each history table. In some embodiments, the adding order could be from the certain pre-defined position of each history table to the beginning of each history table. In another embodiment, the adding order of historical candidate could be in an interleaved manner in each certain history table (e.g., the first added candidates are from the beginning of all history table, the second added candidates are from the end of all history table and so on).

In some embodiments, multiple history tables are used, but not all history tables will be used for creating the candidate list. Only history tables whose regions are close to the region of current block may be used to create the candidate list. In some embodiments, if the historical candidates are used, the range for selecting non-adjacent candidates may be reduced by using smaller distance between each position of non-adjacent candidate. In some embodiments, if the historical candidates are used, the number of non-adjacent candidates could be reduced by measuring the distance from the left-top position of the current block to the candidate position, and then exclude the candidate with the distance greater than a pre-defined threshold. In some embodiments, if the historical candidates are used, the number of non-adjacent candidates may be reduced by skipping the candidates that are not located in the same region. In some embodiments, if the historical candidates are used, the number of non-adjacent candidates may be reduced by skipping the candidates that are not located in the neighboring regions. The range of neighboring regions is pre-defined, and it may be M by N regions where M and N may be any value greater than 0. In some embodiments, if the historical candidates are used, the range for selecting non-adjacent candidates may be reduced by skipping the second search pattern.

In some embodiments, one picture may be divided into several regions, and at least one history table is kept in each region. For a region of the current picture, it may use or combine the history tables of one or multiple regions in the previous coded pictures as the initial history table. For example, if a picture is divided into N regions, it may implicitly or explicitly select the history table from one of N regions in the previously coded pictures as the initial history table. The index of one of N regions could be signaled or implicitly derived from the corresponding region in the previous coded pictures.

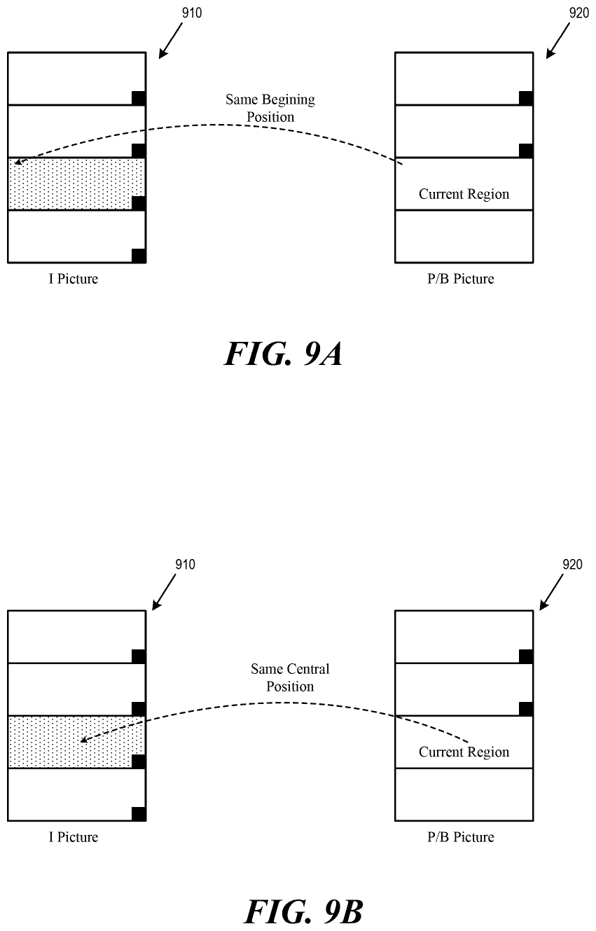

FIGS. 9A-B conceptually illustrate current and reference regions being represented in history tables. The current region is represented by an entry in a history table 920 of the current picture (P/B picture) and the reference region is represented by an entry in a history table 910 of the reference picture (I picture). FIG. 9A illustrates a reference region having a same beginning geometric position as the current region. FIG. 9B illustrates a reference region containing the same center geometric position of the current region. As illustrated, the corresponding region in the previous coded pictures may be the region that has the same beginning geometric position of the current region or contains the center geometric position of the current region. For another example, a video coder may combine more than one history tables in the previous coded regions/pictures to construct the history table of the current region.

g. Available Regions of Temporal Candidates

In some embodiments, to limit the requirement buffer/storage resource, the available range for including temporal candidates are constrained. The temporal candidates mentioned in this section refer to candidates that inherits model parameters from a block in the previous coded slices/pictures, as described in Section III.d above “Inherit temporal neighboring model parameters”. For example, assume the current block position is at (x, y), the positions in the previous coded slices/pictures where the inherited parameter model is from could be (x+Δxᵢ, y+Δyᵢ), i is from 1 to M, and M is a positive integer greater than 0. Δxᵢ and Δyᵢ are pre-defined displacements.

For another example, assume the current block position is at (x, y), the positions in the previous coded slices/pictures where the inherited parameter model is from could be (x+dx+Δxᵢ, y+dy+Δyᵢ), i is from 1 to M, and M is a positive integer greater than 0. Δxᵢ and Δyᵢ are pre-defined displacements. δx and δy are determined by a motion vector of a neighboring block of the current block. The details of how to determine the motion vector is described in Section III.d above.

For another example, assume the current block position is at (x, y), the positions in the previous coded slices/pictures where the inherited parameter model is from may be (x+dx+Δxᵢ, y+dy+Δyᵢ), i is from 1 to M, and M is a positive integer greater than 0. Δxᵢ and Δyᵢ are pre-defined displacements. If the prediction mode of the current block is inter, δx and δy are set to the horizontal and vertical part of motion vector of the current block. If the horizontal part or the vertical part of the motion vector is fractional, dx is set to the horizonal part of the motion vector after rounding and dy is set to the vertical part of the motion vector after rounding. The rounding method used could be but not limited to the following methods: rounding toward negative infinity, rounding toward positive infinity, rounding toward zero, rounding to the nearest integer (e.g., rounding away from zero, rounding half up, rounding half down, . . . ), or rounding to the nearest pre-defined precision (e.g., round to the nearest k-pixel or 1/k-pixel precision position, where k could be 2, 4, 8, 16, or 32). If the prediction mode of the current block is IBC, δx and δy are set to the horizontal and vertical block vector of the current block. If the horizontal part or the vertical part of the block vector is fractional, dx is set to the horizonal part of the block vector after rounding and dy is set to the vertical part of the block vector after rounding. The rounding method used could be but not limited to the following methods: rounding toward negative infinity, rounding toward positive infinity, rounding toward zero, rounding to the nearest integer (e.g., rounding away from zero, rounding half up, rounding half down, . . . ), or rounding to the nearest pre-defined precision (e.g., round to the nearest k-pixel or 1/k-pixel precision position, where k could be 2, 4, 8, 16, or 32).

In some embodiment, only the EIP information of the collocated picture in the CTU whose position in the collocated picture corresponds to the position of the current encoding CTU in the current picture can be referenced by temporal candidates. In some embodiments, only the EIP information of the collocated picture in the CTUs whose positions in the collocated picture correspond to the position of current encoding CTU, and/or left N CTUs, and/or right M CTUs in current picture can be referenced by temporal candidates, where N and M can be any integer greater than 0. In some embodiments, only the EIP information of the collocated picture in the CTU row whose position in collocated picture corresponds to the position of current encoding CTU row in current picture can be referenced by temporal candidates. In some embodiments, only the positions in collocated picture correspond to current CTU row and/or the above N CTU rows and/or below M CTU rows of the current picture can be referenced, where N and M may be any integer greater than 0. As described in Sections III.a and III.b above, the EIP information mentioned in this disclosure may include EIP model derivation information such as, but not limited to, template region selection type (e.g., EIP_T, EIP_L or EIP_LT), size of template region, EIP kernel type (e.g., 4×4 square kernel, 8×2 rectangular kernel or 2×8 rectangular kernel), multi-model flag, classification method for multi-model, threshold for multi-model, fusion flag, fusion method, post-filtering flag, or model parameters.

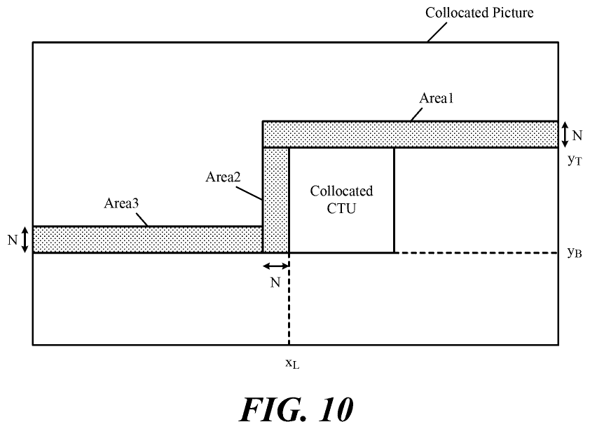

FIG. 10 illustrates the regions available for providing temporal candidates. In the figure, the collocated CTU refers to the CTU in the collocated picture whose position corresponds to the position of the current encoding CTU in the current picture. Let the position of the top-left and bottom left corner of the collocated CTU be (x_{L}, y_{T}) and (x_{L}, y_{B}) respectively. Let the picture width be w. The x, y ranges for each dotted area are defined as following:

$$Area 1 : {x}_{L} - N \leq x < w , {y}_{T} - N \leq y < {y}_{T}$$

$$Area 2 : {x}_{L} - N \leq x < {x}_{L} , {y}_{T} \leq y < {y}_{B}$$

$$Area 3 : 0 \leq x < {x}_{L} - N , {y}_{B} - N < y \leq {y}_{B}$$

N is any positive integer, N>0.

In some embodiments, the temporal candidates may only refer the EIP information in the collocated CTU, in Area1, in Area2 or in Area3, as depicted in FIG. 10. N is set to a pre-defined value. For example, N is set to the minimum allowed block size in the spec. The block could be CU/PU/TU. For another example, N is set to 4. In some embodiments, the region from which the temporal candidates can refer the EIP information is the same as the region from which the temporal motion vector could be referred in inter mode.

h. Available Regions of Non-Adjacent Spatial Candidates

In some embodiments, to limit the requirement of buffer/storage resource, the available range for including non-adjacent spatial candidates are constraint. In some embodiments, only the EIP information in the current CTU can be referenced by non-adjacent spatial candidate. In some embodiments, only the EIP information in the current CTU or left M CTUs can be referenced by non-adjacent spatial candidate, where M can be any integer greater than 0. In some embodiments, only the EIP information in the current CTU row can be referenced by non-adjacent spatial candidate. In some embodiments, only the to-be-referenced position within the current CTU row or the above N CTU rows can be referenced, where N can be any integer greater than 0. The EIP information mentioned in this disclosure includes but not limited to template region selection type (e.g., EIP_T, EIP_L or EIP_LT), size of template region, EIP kernel type (e.g., 4×4 square kernel, 8×2 rectangular kernel or 2×8 rectangular kernel), multi-model flag, classification method for multi-model, threshold for multi-model, fusion flag, fusion method, post-filtering flag, or model parameters.

In some embodiments, the EIP information in the current CTU, current CTU row, current CTU row+above N CTU rows, current CTU+leftM CTUs, or current CTU+above N CTU rows+left M CTUs can be referenced without limits, and the EIP information in other regions can only be referenced by a larger pre-defined unit. For example, the EIP information in current CTU row may be stored within 4×4 grid, and for other EIP information outside current CTU row is stored within 16×16 grid. That is, one 16×16 region only needs to store one EIP information, so the to-be-referenced position shall be rounded to 16×16 grid or changed to the nearest position of 16×16 grid.

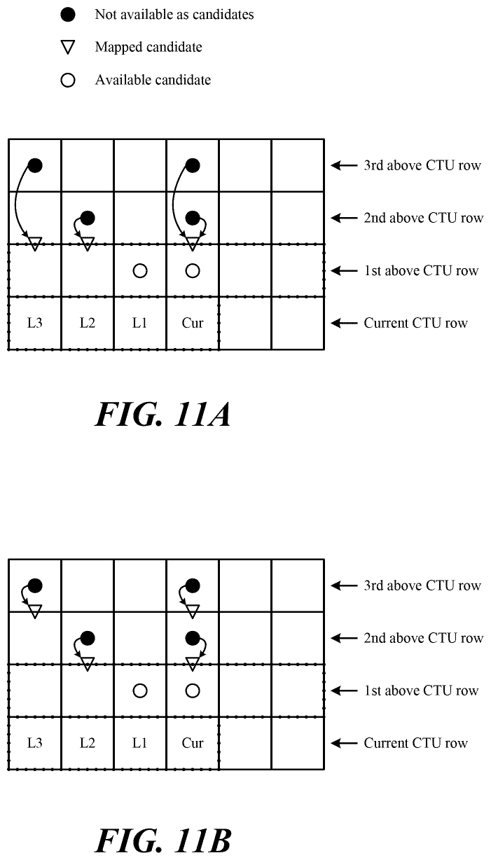

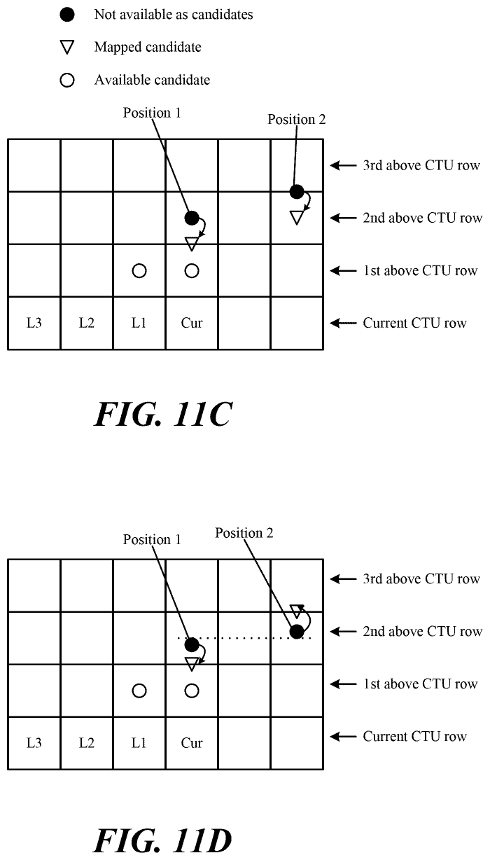

In some embodiments, the EIP information in current CTU row or current CTU row+M CTU rows (M≥0) can be referenced without limits. In some embodiments, for the to-be-referenced positions in the above CTU row (or the current CTU row+M CTU rows), the positions are mapped to a position at the bottom of a CTU row for referencing. This design can preserve most of the coding efficiency and does not require increased buffer size for storing EIP information of above CTU rows. FIG. 11A-D illustrate mapping non-adjacent spatial positions above the current CTU row for inheriting EIP information. The EIP information in current CTU row or current CTU row+M CTU rows can be referenced without limits. FIGS. 11A-D show examples in which M=1, such that the EIP information in current CTU row and the first above CTU row can be referenced without limits. FIG. 11A shows an example in which, for to-be-referenced positions in above second, above third, above fourth CTU row, and so on, the positions are mapped to one line above the first CTU row.

In some embodiments, for the to-be-referenced positions in above CTU rows, the positions are mapped to the last line of that CTU row for referencing. FIG. 11B shows an example in which, when M=1, the EIP information in current CTU row and first CTU row above can be referenced without limits, and for the to-be-referenced positions in above second CTU row, the positions would be mapped to the bottom line of the second above CTU row. For the to-be-referenced positions in above third CTU row, the positions would be mapped to the bottom line of the third above CTU row, and so forth.

In some embodiments, for the to-be-referenced positions in an above CTU row, the positions would be mapped to the last line or bottom line or center line of that CTU row for referencing depended on the position of the to-be-referenced EIP information. For example, as illustrated in FIG. 11C, for a to-be-referenced position 1 in above second CTU row, the position is mapped to the bottom line of the second above CTU row. However, for a to-be-referenced position 2 in second above CTU row, the position is mapped to the center line of the second CTU row since it is closer to the center line compared with bottom line.

In some embodiments, for the to-be-referenced positions in an above CTU row, the positions would be mapped to the last line or bottom line of the that above CTU row for referencing dependent on the position of the to-be-referenced EIP information. For example, as shown in FIG. 11D, for the to-be-referenced position 1 in the second above CTU row, the positions would be mapped to the bottom line of the second above CTU row. However, for the to-be-referenced position 2 in the second above CTU row, the position is mapped to the bottom line of the third above CTU row since position 2 is closer to the bottom line of the third above CTU row compared with bottom line of the second above CTU row.

In some embodiments, the EIP information in current CTU/current CTU+N left CTU can be referenced without limits, and for the left CTUs, the to-be-referenced positions would be mapped to the very right line closed to current CTU/current CTU+N left CTU. For example, the EIP information in current CTU and first left CTU can be referenced without limits, and if the to-be-referenced positions are in second left CTU, the positions would be mapped to one line left to first left CTU. If the to-be-referenced positions are in third left CTU, the positions would be mapped to one line left to first left CTU. For example, the EIP information in current CTU and first left CTU can be referenced without limits, and if the to-be-referenced positions are in second left CTU, the positions would be mapped to the very right line of second left CTU. If the to-be-referenced positions are in third left CTU, the positions would be mapped to the very right line to third left CTU.

In some embodiments, when the available range for including non-adjacent candidates is constraint, if the position of a non-adjacent candidate is outside of the available range, that candidate is skipped and will not be inserted into the candidate list. The available region could be the current CTU, current CTU row, current CTU row+above N CTU rows, current CTU+leftM CTUs, or current CTU+above N CTU rows+leftM CTUs.

j. Constructing a Candidate List

In some embodiments, the candidate list is constructed by adding candidates in a pre-defined order until the maximum candidate number is reached. The candidates added may include all or some of the forementioned candidates, but not limited to the forementioned candidates. For example, the candidate list could include spatial neighboring candidates, temporal neighboring candidate, historical candidates, non-adjacent neighboring candidates, single model candidates generated based on other inherited models. For another example, the candidate list could include the same candidates as previous example, but the candidates are added into the list in different order.

In some embodiments, if all the pre-defined neighboring and historical candidates are added but the maximum candidate number is not reached, some default candidates are added into the candidate list until the maximum candidate number is reached. In some embodiment, a default candidate may be a shortcut to indicate an EIP mode (i.e., uses the current neighboring reconstruction samples to derive EIP models) rather than inheriting parameters from neighbors. For example, default candidate could be EIP_LT, EIP_L, EIP_T.

In some embodiments, a default candidate may be the first model of an earlier multi-model EIP candidate (i.e., the model used when the sample value is less than or equal to classification threshold). In some embodiments, a default candidate may be the second model of an earlier multi-model EIP candidate (i.e., the model used when the sample value is greater than or equal to classification threshold). In some embodiments, a default candidate may be the combination of two models of an earlier multi-model EIP candidate. For example, if the models of an earlier multi-model EIP candidate are

$$\{ {c}_{0}^{0} , {c}_{1}^{0} , … , {c}_{M - 1}^{0} \} and \{ {c}_{0}^{1} , {c}_{1}^{1} , … , {c}_{M - 1}^{1} \} .$$

The model parameters of an default

$$\{ ( 1 - α ) \times {c}_{0}^{0} + α \times {c}_{0}^{1} , ( 1 - α ) \times {c}_{1}^{0} + α \times {c}_{1}^{1} , … , ( 1 - α ) \times {c}_{M - 1}^{0} + α \times {c}_{M - 1}^{1} \} ,$$

where α is a weighting factor which could be predefined or implicitly derived by neighboring template cost, and

$${c}_{x}^{y}$$

is the x-th parameter of the y-th model.

In some embodiments, default candidates may be derived from reconstructed samples from non-adjacent neighboring regions. Let the current block position be at (x, y) and the block size be w×h. If the reconstructed samples in the M×N region located at (x+dx, y+dy) are “available”, the default candidates can be derived using reconstructed samples in the region. For example, M×N could be 8×8. For another example, M×N could be 16×8. For another example, M×N could be 16×16. For another example, M×N may be w×h. The meaning of “available” can be the reconstructed sample inside the current block is available, or the reconstructed sample inside the k lines of neighboring samples is available.

In some embodiments, default candidates derived from reconstructed samples from non-adjacent neighboring regions may be any type of EIP model or some particular types of EIP model. For example, the derived model may be EIP, multi-model EIP. For another example, the derived model is EIP model.

In some embodiments, when constructing a candidate list, candidates are included into the list according to a pre-defined order. For example, the pre-defined order could be spatial adjacent candidates, temporal candidates, spatial non-adjacent candidates, historical candidates, and then default candidates.

When constructing a candidate list, the video coder may allow only the candidate with a certain prediction mode to be added into the list. For example, the video coder may allow only the candidates derived by EIP or multi-model EIP modes be added into the list. For another example, the video coder may allow only the candidates derived by single-model modes to be added into the list. For another example, the video coder may allow only the candidates derived by multi-model modes to be added into the list. In some embodiments, if only the candidate of a certain prediction mode can be added into the list, the video coder may signal the prediction mode first and then signal whether EIP merge mode is used or not. If EIP merge mode is used, then the candidate index is signaled.

m. Signaling the Candidate Selection from the List

In some embodiments, an on/off flag is signaled to indicate whether the current block inherits the EIP model information from neighboring blocks or not. The flag can be signaled per CU/CB, per PU, per TU/TB, or per color component. A high-level syntax may be signaled in SPS, PPS, PH or SH to indicate if the proposed method is allowed for the current sequence, picture, or slice.

In some embodiments, the EIP model inheritance on/off flag may have multiple context model, and the selection of multiple context models may depend on the block size, number of neighboring inter coded block, number of neighboring EIP coded block, or number of neighboring inherited EIP coded block.

In some embodiments, the maximum allowed candidate number is signaled to indicate the maximum size of the merge candidate list. The number can be signaled per CU/CB, per PU, per TU/TB, or per color component. A high-level syntax may be signaled in SPS, PPS, PH or SH to indicate the maximum allowed candidate number for the current sequence, picture, or slice. In some embodiments, the maximum allowed candidate number may be shared with the maximum allowed candidate number for inter merge mode.

In some embodiments, if the current block inherits the EIP model parameters from neighboring blocks, the inherit candidate index is signaled. The index may be signaled (e.g., signaled using truncate unary code, Exp-Golomb code, or fix length code) for each color component. For another example, the index of chroma component could be signaled and shared among Cb and Cr blocks. In some embodiments, the candidate index is implicitly derived as the first candidate in the candidate list. In some embodiments, the candidate index is implicitly derived as the first candidate in the candidate list after list reordering according to costs associated with candidates in the list.

### IV. EXAMPLE VIDEO ENCODER

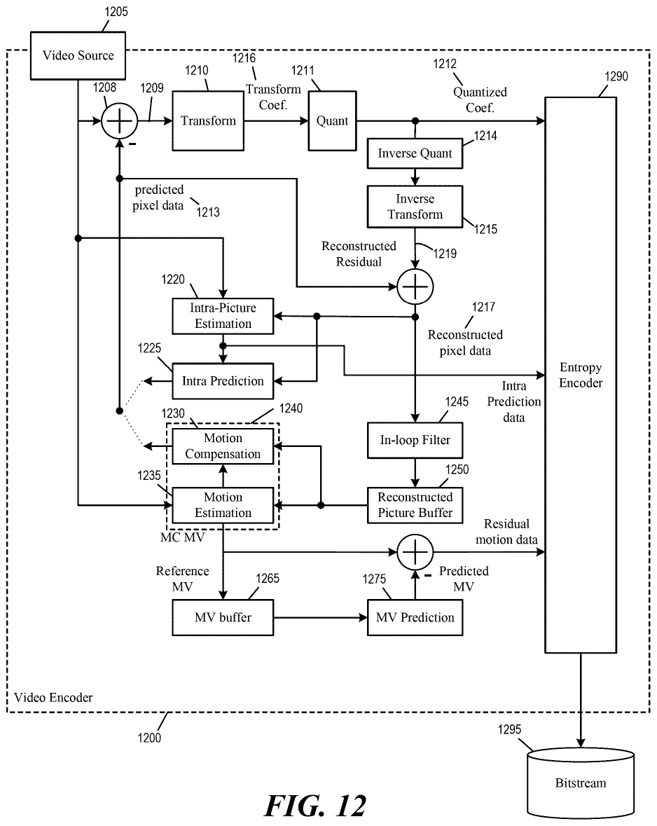

FIG. 12 illustrates an example video encoder 1200 that may implement EIP. As illustrated, the video encoder 1200 receives input video signal from a video source 1205 and encodes the signal into bitstream 1295. The video encoder 1200 has several components or modules for encoding the signal from the video source 1205, at least including some components selected from a transform module 1210, a quantization module 1211, an inverse quantization module 1214, an inverse transform module 1215, an intra-picture estimation module 1220, an intra-prediction module 1225, a motion compensation module 1230, a motion estimation module 1235, an in-loop filter 1245, a reconstructed picture buffer 1250, a MV buffer 1265, and a MV prediction module 1275, and an entropy encoder 1290. The motion compensation module 1230 and the motion estimation module 1235 are part of an inter-prediction module 1240.

In some embodiments, the modules 1210-1290 are modules of software instructions being executed by one or more processing units (e.g., a processor) of a computing device or electronic apparatus. In some embodiments, the modules 1210-1290 are modules of hardware circuits implemented by one or more integrated circuits (ICs) of an electronic apparatus. Though the modules 1210-1290 are illustrated as being separate modules, some of the modules can be combined into a single module.

The video source 1205 provides a raw video signal that presents pixel data of each video frame without compression. A subtractor 1208 computes the difference between the raw video pixel data of the video source 1205 and the predicted pixel data 1213 from the motion compensation module 1230 or intra-prediction module 1225 as prediction residual 1209. The transform module 1210 converts the difference (or the residual pixel data or residual signal 1209) into transform coefficients (e.g., by performing Discrete Cosine Transform, or DCT). The quantization module 1211 quantizes the transform coefficients into quantized data (or quantized coefficients) 1212, which is encoded into the bitstream 1295 by the entropy encoder 1290.

The inverse quantization module 1214 de-quantizes the quantized data (or quantized coefficients) 1212 to obtain transform coefficients, and the inverse transform module 1215 performs inverse transform on the transform coefficients to produce reconstructed residual 1219. The reconstructed residual 1219 is added with the predicted pixel data 1213 to produce reconstructed pixel data 1217. In some embodiments, the reconstructed pixel data 1217 is temporarily stored in a line buffer (not illustrated) for intra-picture prediction and spatial MV prediction. The reconstructed pixels are filtered by the in-loop filter 1245 and stored in the reconstructed picture buffer 1250. In some embodiments, the reconstructed picture buffer 1250 is a storage external to the video encoder 1200. In some embodiments, the reconstructed picture buffer 1250 is a storage internal to the video encoder 1200.

The intra-picture estimation module 1220 performs intra-prediction based on the reconstructed pixel data 1217 to produce intra prediction data. The intra-prediction data is provided to the entropy encoder 1290 to be encoded into bitstream 1295. The intra-prediction data is also used by the intra-prediction module 1225 to produce the predicted pixel data 1213.

The motion estimation module 1235 performs inter-prediction by producing MVs to reference pixel data of previously decoded frames stored in the reconstructed picture buffer 1250. These MVs are provided to the motion compensation module 1230 to produce predicted pixel data.

Instead of encoding the complete actual MVs in the bitstream, the video encoder 1200 uses MV prediction to generate predicted MVs, and the difference between the MVs used for motion compensation and the predicted MVs is encoded as residual motion data and stored in the bitstream 1295.

The MV prediction module 1275 generates the predicted MVs based on reference MVs that were generated for encoding previously video frames, i.e., the motion compensation MVs that were used to perform motion compensation. The MV prediction module 1275 retrieves reference MVs from previous video frames from the MV buffer 1265. The video encoder 1200 stores the MVs generated for the current video frame in the MV buffer 1265 as reference MVs for generating predicted MVs.

The MV prediction module 1275 uses the reference MVs to create the predicted MVs. The predicted MVs can be computed by spatial MV prediction or temporal MV prediction. The difference between the predicted MVs and the motion compensation MVs (MC MVs) of the current frame (residual motion data) are encoded into the bitstream 1295 by the entropy encoder 1290.

The entropy encoder 1290 encodes various parameters and data into the bitstream 1295 by using entropy-coding techniques such as context-adaptive binary arithmetic coding (CABAC) or Huffman encoding. The entropy encoder 1290 encodes various header elements, flags, along with the quantized transform coefficients 1212, and the residual motion data as syntax elements into the bitstream 1295. The bitstream 1295 is in turn stored in a storage device or transmitted to a decoder over a communications medium such as a network.

The in-loop filter 1245 performs filtering or smoothing operations on the reconstructed pixel data 1217 to reduce the artifacts of coding, particularly at boundaries of pixel blocks. In some embodiments, the filtering or smoothing operations performed by the in-loop filter 1245 include deblock filter (DBF), sample adaptive offset (SAO), and/or adaptive loop filter (ALF). In some embodiments, luma mapping chroma scaling (LMCS) is performed before the loop filters.

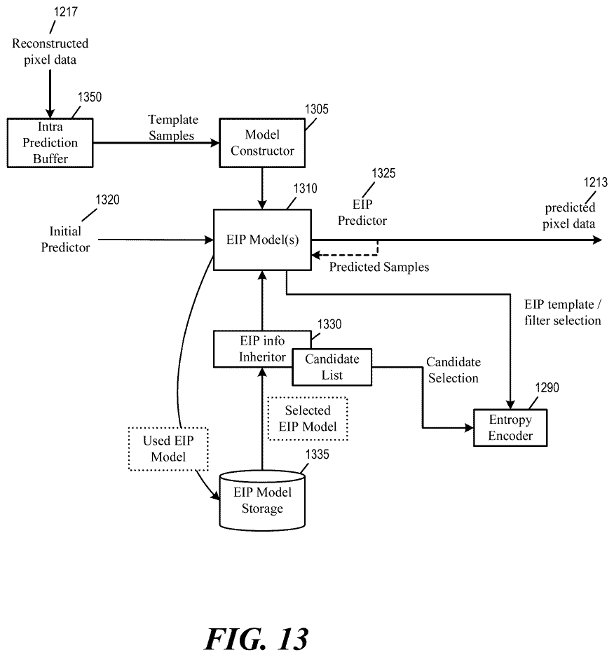

FIG. 13 illustrates portions of the video encoder 1200 that implement EIP information inheritance. An intra-prediction buffer 1350 stores samples of reconstructed pixel data 1217 taken before the in-loop filters and provide the stored samples as template samples for an EIP model constructor 1305. The template samples are from regions that are defined by a selected template region type, namely one of EIP_T, EIP_L, and EIP_LT, as described by reference to FIG. 2 above. The retrieved template samples may be used to derive a EIP model 1310 by regression according to a selected shape, as described by reference to FIG. 1 above. The EIP model 1310 is a filter that includes a set of coefficients for a set of filter taps (e.g. 15 taps). The selection of the template region and of the filter shape are provided to the entropy encoder 1290 to be signaled in the bitstream 1295.

The video encoder 1200 may apply the EIP model 1310 to an initial predictor 1320, which may be reconstructed samples neighboring the current block, or predicted sample of the current block, to generate a EIP predictor 1325 according to Eq.(1) described in Section I.e above. The EIP model traverses the current block to generate the samples of the predictor according to a diagonal pattern as described by reference to FIG. 3 above.

This EIP predictor 1325 may serve as the final predictor of the current block and as the predicted pixel data 1213. Once generated, the EIP model 1310 and the information related to its derivation may be stored in a EIP model storage 1335. The model derivation information may include selection of template region (e.g., EIP_T, EIP_L, or EIP_LT), size of template region, kernel type (e.g., 4×4 square kernel, 8×2 rectangular kernel or 2×8 rectangular kernel), multi-model flag, classification method for multi-model, threshold for multi-model, fusion flag, fusion method, post-filtering flag, or model parameters, etc.

The EIP model 1310 may also be inherited from previously coded blocks. In some embodiments, when inheriting a EIP model, the information related to the model's derivation are also inherited, in addition to the coefficients and the offsets of the model. When the EIP model 1310 is generated and used, it is stored in a EIP model storage 1335 along with the model's derivation information to be inherited by subsequent blocks. When a subsequently coded block inherits an EIP linear model, a EIP information inheritor 1330 provides the linear model parameters along with its derivation information, by retrieving the information from the EIP model storage 1335. The EIP information inheritor 1330 may identify and fetch candidates of different types, such as spatial candidates (described in Section III.c above), non-adjacent spatial candidates (described in Section III.e above), temporal candidates (described in Section III.d above), and historical candidates from history tables (described in Section III.f above).

The EIP information inheritor 1330 may construct a candidate list that includes one or more candidate EIP linear models. The candidate list may include candidates of different types. History tables for implementing history candidate may be stored in the EIP model storage 1335. The selection of the candidate is relayed to the entropy encoder 1290 to be encoded into the bitstream 1295.

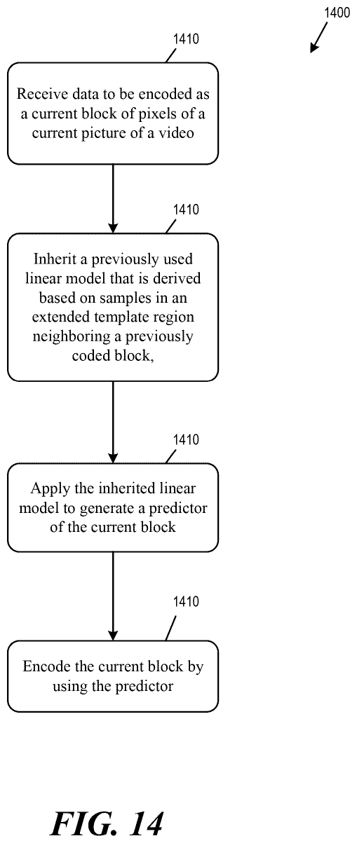

FIG. 14 conceptually illustrates a process 1400 for using inherited EIP model to encode a current block. In some embodiments, one or more processing units (e.g., a processor) of a computing device implementing the encoder 1200 performs the process 1400 by executing instructions stored in a computer readable medium. In some embodiments, an electronic apparatus implementing the encoder 1200 performs the process 1400.

The encoder receives (at block 1410) data to be encoded as a current block of pixels in a current picture. The encoder inherits (at block 1420) a previously used (EIP) linear model that is derived based on reconstructed samples in a template region neighboring a previously coded block. The template region occupies an area that extends beyond at least one of top and left edges of the previously coded block. In some embodiment, the area occupied by the template region extends by predefined numbers of pixel positions.

In some embodiments, inheriting the linear model includes inheriting a set of filter coefficients, offset values to be applied to filter taps corresponding to the set of filter coefficients, and maximum and minimum values for constraining the output of the linear model. In some embodiments, inheriting the linear model also includes inheriting information regarding the derivation of the linear model. The derivation information may include a selection of a type of template region from multiple types of template region comprising above template region type, left template region type, and above-left template region type. The derivation information may also include a selection of a filter kernel type from multiple different filter kernel types having different shapes.

The linear model may be a spatial candidate inherited from a spatial neighbor of the current block (described in Section III.c above). The linear model may be a non-adjacent spatial candidate inherited from a non-adjacent spatial neighbor of the current block (described in Section III.e above). The inherited linear model may be a historical candidate identified by using a history table that stores a history of one or more previously used linear models (described in Section III.f above). The linear model may be a temporal candidate (described in Section III.d above) inherited from a neighboring position of a corresponding position of the current block in a reference picture, with the neighboring position constrained to be within a region in the reference picture that is defined based on the corresponding position of the current block in the reference picture. In some embodiments, the encoder constructs a candidate list that includes one or more linear models, such that inheriting the linear model includes signaling a selection of the linear model from the constructed candidate list.

The encoder applies (at block 1430) the inherited linear model to generate a predictor of the current block. In some embodiments, the inherited linear model is a filter that uses reconstructed samples or predicted samples of the current block as input to the filter to generate samples of the predictor. The encoder encodes (at block 1440) the current block by using the predictor to produce prediction residuals.

### V. EXAMPLE VIDEO DECODER

In some embodiments, an encoder may signal (or generate) one or more syntax element in a bitstream, such that a decoder may parse said one or more syntax element from the bitstream.

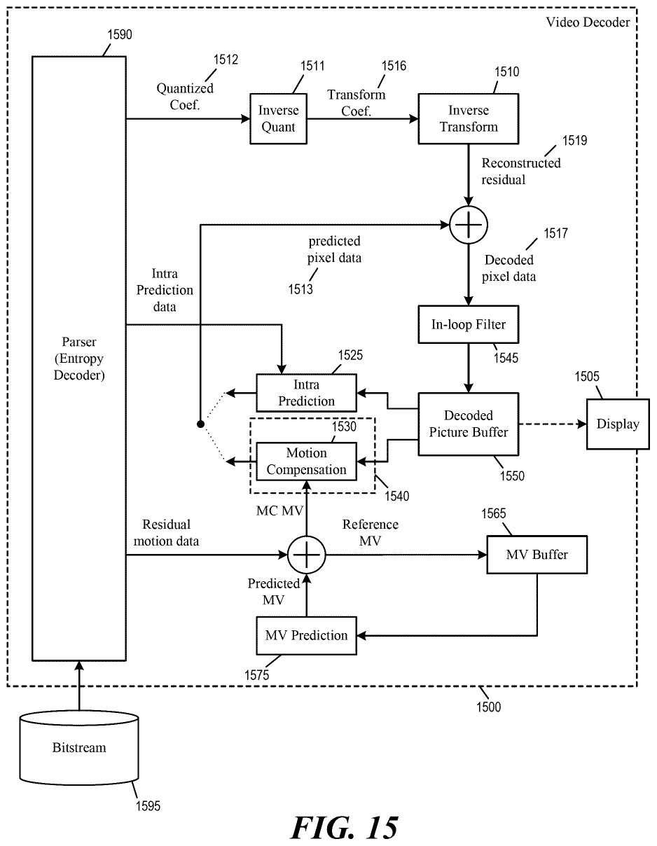

FIG. 15 illustrates an example video decoder 1500 that may implement EIP. As illustrated, the video decoder 1500 is an image-decoding or video-decoding circuit that receives a bitstream 1595 and decodes the content of the bitstream into pixel data of video frames for display. The video decoder 1500 has several components or modules for decoding the bitstream 1595, including some components selected from an inverse quantization module 1511, an inverse transform module 1510, an intra-prediction module 1525, a motion compensation module 1530, an in-loop filter 1545, a decoded picture buffer 1550, a MV buffer 1565, a MV prediction module 1575, and a parser 1590. The motion compensation module 1530 is part of an inter-prediction module 1540.

In some embodiments, the modules 1510-1590 are modules of software instructions being executed by one or more processing units (e.g., a processor) of a computing device. In some embodiments, the modules 1510-1590 are modules of hardware circuits implemented by one or more ICs of an electronic apparatus. Though the modules 1510-1590 are illustrated as being separate modules, some of the modules can be combined into a single module.

The parser 1590 (or entropy decoder) receives the bitstream 1595 and performs initial parsing according to the syntax defined by a video-coding or image-coding standard. The parsed syntax element includes various header elements, flags, as well as quantized data (or quantized coefficients) 1512. The parser 1590 parses out the various syntax elements by using entropy-coding techniques such as context-adaptive binary arithmetic coding (CABAC) or Huffman encoding.

The inverse quantization module 1511 de-quantizes the quantized data (or quantized coefficients) 1512 to obtain transform coefficients, and the inverse transform module 1510 performs inverse transform on the transform coefficients 1516 to produce reconstructed residual signal 1519. The reconstructed residual signal 1519 is added with predicted pixel data 1513 from the intra-prediction module 1525 or the motion compensation module 1530 to produce decoded pixel data 1517. The decoded pixels data are filtered by the in-loop filter 1545 and stored in the decoded picture buffer 1550. In some embodiments, the decoded picture buffer 1550 is a storage external to the video decoder 1500. In some embodiments, the decoded picture buffer 1550 is a storage internal to the video decoder 1500.

The intra-prediction module 1525 receives intra-prediction data from bitstream 1595 and according to which, produces the predicted pixel data 1513 from the decoded pixel data 1517 stored in the decoded picture buffer 1550. In some embodiments, the decoded pixel data 1517 is also stored in a line buffer (not illustrated) for intra-picture prediction and spatial MV prediction.

In some embodiments, the content of the decoded picture buffer 1550 is used for display. A display device 1505 either retrieves the content of the decoded picture buffer 1550 for display directly, or retrieves the content of the decoded picture buffer to a display buffer. In some embodiments, the display device receives pixel values from the decoded picture buffer 1550 through a pixel transport.

The motion compensation module 1530 produces predicted pixel data 1513 from the decoded pixel data 1517 stored in the decoded picture buffer 1550 according to motion compensation MVs (MC MVs). These motion compensation MVs are decoded by adding the residual motion data received from the bitstream 1595 with predicted MVs received from the MV prediction module 1575.

The MV prediction module 1575 generates the predicted MVs based on reference MVs that were generated for decoding previous video frames, e.g., the motion compensation MVs that were used to perform motion compensation. The MV prediction module 1575 retrieves the reference MVs of previous video frames from the MV buffer 1565. The video decoder 1500 stores the motion compensation MVs generated for decoding the current video frame in the MV buffer 1565 as reference MVs for producing predicted MVs.

The in-loop filter 1545 performs filtering or smoothing operations on the decoded pixel data 1517 to reduce the artifacts of coding, particularly at boundaries of pixel blocks. In some embodiments, the filtering or smoothing operations performed by the in-loop filter 1545 include deblock filter (DBF), sample adaptive offset (SAO), and/or adaptive loop filter (ALF). In some embodiments, luma mapping chroma scaling (LMCS) is performed before the loop filters.

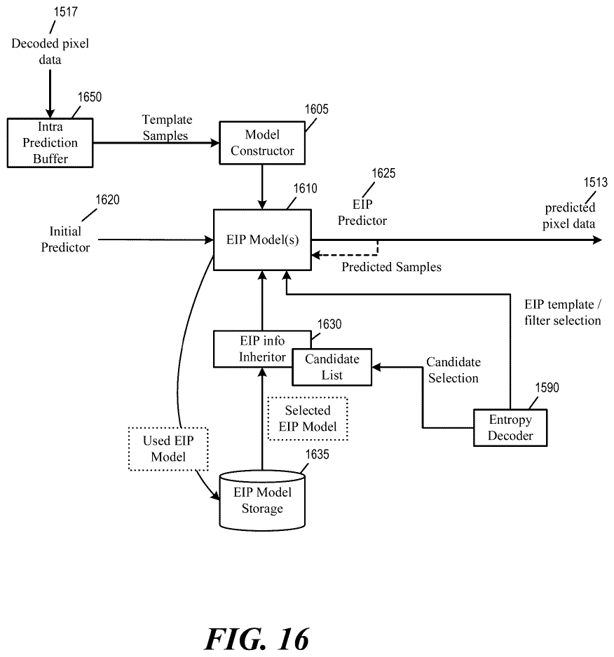

FIG. 16 illustrates portions of the video decoder 1500 that implement EIP information inheritance. An intra-prediction buffer 1650 stores samples of decoded pixel data 1517 taken before the in-loop filters and provide the stored samples as template samples for an EIP model constructor 1605. The template samples are from regions that are defined by a selected template region type, namely one of EIP_T, EIP_L, and EIP_LT, as described by reference to FIG. 2 above. The retrieved template samples may be used to derive a EIP model 1610 by regression according to a selected shape, as described by reference to FIG. 1 above. The EIP model 1610 is a filter that includes a set of coefficients for a set of filter taps (e.g. 15 taps). The selection of the template region and of the filter shape are provided by the entropy decoder 1590, which parses the selection from the bitstream 1595.

The video decoder 1500 may apply the EIP model 1610 to an initial predictor 1620, which may be reconstructed samples neighboring the current block, or predicted sample of the current block, to generate a EIP predictor 1625 according to Eq.(1) described in Section I.e above. The EIP model traverses the current block to generate the samples of the predictor according to a diagonal pattern as described by reference to FIG. 3 above.

This EIP predictor 1625 may serve as the final predictor of the current block and as the predicted pixel data 1513. Once generated, the EIP model 1610 and the information related to its derivation may be stored in a EIP model storage 1635. The model derivation information may include selection of template region (e.g., EIP_T, EIP_L, or EIP_LT), size of template region, kernel type (e.g., 4×4 square kernel, 8×2 rectangular kernel or 2×8 rectangular kernel), multi-model flag, classification method for multi-model, threshold for multi-model, fusion flag, fusion method, post-filtering flag or model parameters, etc.

The EIP model 1610 may also be inherited from previously coded blocks. In some embodiments, when inheriting a linear model, the information related to the model's derivation are also inherited, in addition to the coefficients and the offsets of the model. When the EIP model 1610 is generated and used, it is stored in a EIP model storage 1635 along with the model's derivation information to be inherited by subsequent blocks. When a subsequently coded block inherits an EIP linear model, a EIP information inheritor 1630 provides the linear model parameters along with its derivation information, by retrieving the information from the EIP model storage 1635. The EIP information inheritor 1630 may identify and fetch candidates of different types, such as spatial candidates (described in Section III.c above), non-adjacent spatial candidates (described in Section III.e above), temporal candidates (described in Section III.d above), and historical candidates from history tables (described in Section III.f above).

The EIP information inheritor 1630 may construct a candidate list that includes one or more candidate EIP linear models. The candidate list may include candidates of different types. History tables for implementing history candidate may be stored in the EIP model storage 1635. The selection of the candidate may be provided by the entropy decoder 1590 by parsing the bitstream 1595.

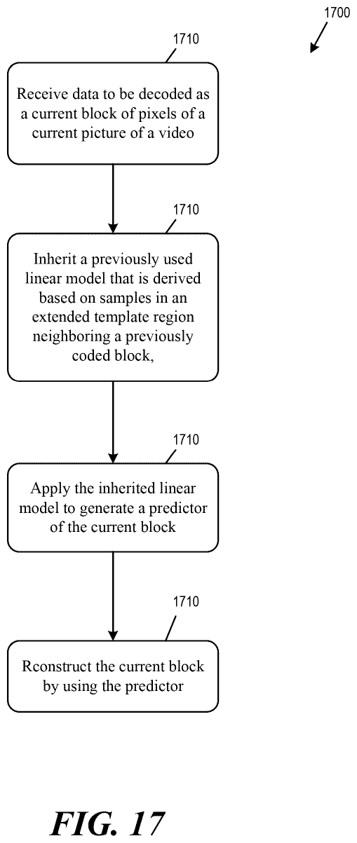

FIG. 17 conceptually illustrates a process 1700 for using inherited EIP model to decode a current block. In some embodiments, one or more processing units (e.g., a processor) of a computing device implementing the decoder 1200 performs the process 1700 by executing instructions stored in a computer readable medium. In some embodiments, an electronic apparatus implementing the decoder 1200 performs the process 1700.

The decoder receives (at block 1710) data to be decoded as a current block of pixels in a current picture. The decoder inherits (at block 1720) a previously used (EIP) linear model that is derived based on reconstructed samples in a template region neighboring a previously coded block. The template region occupies an area that extends beyond at least one of top and left edges of the previously coded block by predefined numbers of pixel positions.

In some embodiments, inheriting the linear model includes inheriting a set of filter coefficients, offset values to be applied to filter taps corresponding to the set of filter coefficients, and maximum and minimum values for constraining the output of the linear model. In some embodiments, inheriting the linear model also includes inheriting information regarding the derivation of the linear model. The derivation information may include a selection of a type of template region from multiple types of template region comprising above template region type, left template region type, and above-left template region type. The derivation information may also include a selection of a filter kernel type from multiple different filter kernel types having different shapes.

The linear model may be a spatial candidate inherited from a spatial neighbor of the current block (described in Section III.c above). The linear model may be a non-adjacent spatial candidate inherited from a non-adjacent spatial neighbor of the current block (described in Section III.e above). The inherited linear model may be a historical candidate identified by using a history table that stores a history of one or more previously used linear models (described in Section III.f above). The linear model may be a temporal candidate (described in Section III.d above) inherited from a neighboring position of a corresponding position of the current block in a reference picture, with the neighboring position constrained to be within a region in the reference picture that is defined based on the corresponding position of the current block in the reference picture. In some embodiments, the decoder constructs a candidate list that includes one or more linear models, such that inheriting the linear model includes receiving a selection of the linear model from the constructed candidate list.

The decoder applies (at block 1730) the inherited linear model to generate a predictor of the current block. In some embodiments, the inherited linear model is a filter that uses reconstructed samples or predicted samples of the current block as input to the filter to generate samples of the predictor. The decoder reconstructs (at block 1740) the current block by using the predictor and prediction residuals. The decoder may then provide the reconstructed current block for display as part of the reconstructed current picture.

### VI. EXAMPLE ELECTRONIC SYSTEM

Many of the above-described features and applications are implemented as software processes that are specified as a set of instructions recorded on a computer readable storage medium (also referred to as computer readable medium). When these instructions are executed by one or more computational or processing unit(s) (e.g., one or more processors, cores of processors, or other processing units), they cause the processing unit(s) to perform the actions indicated in the instructions. Examples of computer readable media include, but are not limited to, CD-ROMs, flash drives, random-access memory (RAM) chips, hard drives, erasable programmable read only memories (EPROMs), electrically erasable programmable read-only memories (EEPROMs), etc. The computer readable media does not include carrier waves and electronic signals passing wirelessly or over wired connections.

In this specification, the term “software” is meant to include firmware residing in read-only memory or applications stored in magnetic storage which can be read into memory for processing by a processor. Also, in some embodiments, multiple software inventions can be implemented as sub-parts of a larger program while remaining distinct software inventions. In some embodiments, multiple software inventions can also be implemented as separate programs. Finally, any combination of separate programs that together implement a software invention described here is within the scope of the present disclosure. In some embodiments, the software programs, when installed to operate on one or more electronic systems, define one or more specific machine implementations that execute and perform the operations of the software programs.

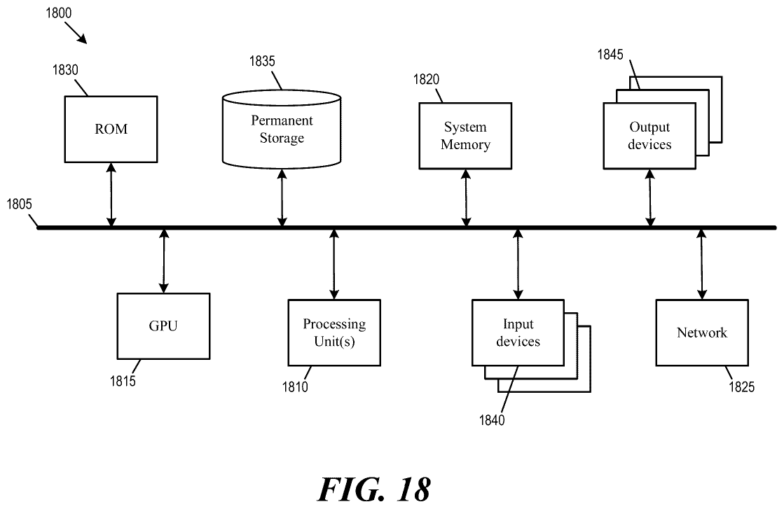

FIG. 18 conceptually illustrates an electronic system 1800 with which some embodiments of the present disclosure are implemented. The electronic system 1800 may be a computer (e.g., a desktop computer, personal computer, tablet computer, etc.), phone, PDA, or any other sort of electronic device. Such an electronic system includes various types of computer readable media and interfaces for various other types of computer readable media. Electronic system 1800 includes a bus 1805, processing unit(s) 1810, a graphics-processing unit (GPU) 1815, a system memory 1820, a network 1825, a read-only memory 1830, a permanent storage device 1835, input devices 1840, and output devices 1845.

The bus 1805 collectively represents all system, peripheral, and chipset buses that communicatively connect the numerous internal devices of the electronic system 1800. For instance, the bus 1805 communicatively connects the processing unit(s) 1810 with the GPU 1815, the read-only memory 1830, the system memory 1820, and the permanent storage device 1835.

From these various memory units, the processing unit(s) 1810 retrieves instructions to execute and data to process in order to execute the processes of the present disclosure. The processing unit(s) may be a single processor or a multi-core processor in different embodiments. Some instructions are passed to and executed by the GPU 1815. The GPU 1815 can offload various computations or complement the image processing provided by the processing unit(s) 1810.

The read-only-memory (ROM) 1830 stores static data and instructions that are used by the processing unit(s) 1810 and other modules of the electronic system. The permanent storage device 1835, on the other hand, is a read-and-write memory device. This device is a non-volatile memory unit that stores instructions and data even when the electronic system 1800 is off. Some embodiments of the present disclosure use a mass-storage device (such as a magnetic or optical disk and its corresponding disk drive) as the permanent storage device 1835.

Other embodiments use a removable storage device (such as a floppy disk, flash memory device, etc., and its corresponding disk drive) as the permanent storage device. Like the permanent storage device 1835, the system memory 1820 is a read-and-write memory device. However, unlike storage device 1835, the system memory 1820 is a volatile read-and-write memory, such a random access memory. The system memory 1820 stores some of the instructions and data that the processor uses at runtime. In some embodiments, processes in accordance with the present disclosure are stored in the system memory 1820, the permanent storage device 1835, and/or the read-only memory 1830. For example, the various memory units include instructions for processing multimedia clips in accordance with some embodiments. From these various memory units, the processing unit(s) 1810 retrieves instructions to execute and data to process in order to execute the processes of some embodiments.

The bus 1805 also connects to the input and output devices 1840 and 1845. The input devices 1840 enable the user to communicate information and select commands to the electronic system. The input devices 1840 include alphanumeric keyboards and pointing devices (also called “cursor control devices”), cameras (e.g., webcams), microphones or similar devices for receiving voice commands, etc. The output devices 1845 display images generated by the electronic system or otherwise output data. The output devices 1845 include printers and display devices, such as cathode ray tubes (CRT) or liquid crystal displays (LCD), as well as speakers or similar audio output devices. Some embodiments include devices such as a touchscreen that function as both input and output devices.

Finally, as shown in FIG. 18, bus 1805 also couples electronic system 1800 to a network 1825 through a network adapter (not shown). In this manner, the computer can be a part of a network of computers (such as a local area network (“LAN”), a wide area network (“WAN”), or an Intranet, or a network of networks, such as the Internet. Any or all components of electronic system 1800 may be used in conjunction with the present disclosure.

Some embodiments include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra-density optical discs, any other optical or magnetic media, and floppy disks. The computer-readable media may store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, many of the above-described features and applications are performed by one or more integrated circuits, such as application specific integrated circuits (ASICs) or field programmable gate arrays (FPGAs). In some embodiments, such integrated circuits execute instructions that are stored on the circuit itself. In addition, some embodiments execute software stored in programmable logic devices (PLDs), ROM, or RAM devices.

As used in this specification and any claims of this application, the terms “computer”, “server”, “processor”, and “memory” all refer to electronic or other technological devices. These terms exclude people or groups of people. For the purposes of the specification, the terms display or displaying means displaying on an electronic device. As used in this specification and any claims of this application, the terms “computer readable medium,” “computer readable media,” and “machine readable medium” are entirely restricted to tangible, physical objects that store information in a form that is readable by a computer. These terms exclude any wireless signals, wired download signals, and any other ephemeral signals.

While the present disclosure has been described with reference to numerous specific details, one of ordinary skill in the art will recognize that the present disclosure can be embodied in other specific forms without departing from the spirit of the present disclosure. In addition, a number of the figures (including FIG. 14 and FIG. 17) conceptually illustrate processes. The specific operations of these processes may not be performed in the exact order shown and described. The specific operations may not be performed in one continuous series of operations, and different specific operations may be performed in different embodiments. Furthermore, the process could be implemented using several sub-processes, or as part of a larger macro process. Thus, one of ordinary skill in the art would understand that the present disclosure is not to be limited by the foregoing illustrative details, but rather is to be defined by the appended claims.

### ADDITIONAL NOTES

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermediate components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A video coding method comprising:
receiving data to be encoded or decoded as a current block of pixels of a current picture of a video;
inheriting a previously used linear model for extrapolation intra prediction (EIP) that is derived based on samples in a template region neighboring a previously coded block, the template region occupying an area that extends beyond at least one of top and left edges of the previously coded block;
applying the inherited linear model to generate a predictor of the current block by using reconstructed samples or predicted samples of the current block as input to a filter to generate samples of the predictor; and
encoding or decoding the current block by using the predictor.

2. The video coder of claim 1, wherein inheriting the linear model comprises inheriting a set of filter coefficients.

3. The video coder of claim 2, wherein inheriting the linear model comprises inheriting offset values to be applied to filter taps corresponding to the set of filter coefficients.

4. The video coder of claim 2, wherein inheriting the linear model comprises inheriting maximum and minimum values for constraining the output of the linear model.

5. The video coder of claim 1, wherein inheriting the linear model comprises inheriting information regarding a derivation of the linear model.

6. The video coder of claim 5, wherein the information comprises a selection of a type of template region from multiple types of template region comprising above template region type, left template region type, and above-left template region type.

7. The video coder of claim 5, wherein the information comprises a selection of a filter kernel type from multiple different filter kernel types having different shapes.

8. The video coder of claim 1, wherein the linear model is inherited from a spatial neighbor of the current block.

9. The video coder of claim 1, wherein the linear model is inherited from a non-adjacent spatial neighbor of the current block.

10. The video coder of claim 1, wherein the inherited linear model is identified by using a history table that stores a history of one or more previously used linear models.

11. The video coder of claim 1, wherein the linear model is inherited from a neighboring position of a corresponding position of the current block in a reference picture.

12. The video coder of claim 11, wherein the neighboring position is constrained to be within a region in the reference picture that is defined based on the corresponding position of the current block in the reference picture.

13. The video coder of claim 1, further comprising constructing a candidate list that includes one or more linear models, wherein inheriting the linear model comprises signaling or receiving a selection of the linear model from the constructed candidate list.

14. An electronic apparatus comprising:
a video coder circuit configured to perform operations comprising:
receiving data to be encoded or decoded as a current block of pixels of a current picture of a video;
inheriting a previously used linear model for extrapolation intra prediction (EIP) that is derived based on samples in a template region neighboring a previously coded block, the template region occupying an area that extends beyond at least one of top and left edges of the previously coded block;
applying the inherited linear model to generate a predictor of the current block by using reconstructed samples or predicted samples of the current block as input to a filter to generate samples of the predictor; and
encoding or decoding the current block by using the predictor.

15. A video decoding method comprising:
receiving data to be decoded as a current block of pixels of a current picture of a video;
inheriting a previously used linear model for extrapolation intra prediction (EIP) that is derived based on samples in a template region neighboring a previously coded block, the template region occupying an area that extends beyond at least one of top and left edges of the previously coded block;
applying the inherited linear model to generate a predictor of the current block by using reconstructed samples or predicted samples of the current block as input to a filter to generate samples of the predictor; and
reconstructing the current block by using the predictor.

16. A video encoding method comprising:
receiving data to be encoded as a current block of pixels of a current picture of a video;
inheriting a previously used linear model for extrapolation intra prediction (EIP) that is derived based on samples in a template region neighboring a previously coded block, the template region occupying an area that extends beyond at least one of top and left edges of the previously coded block;
applying the inherited linear model to generate a predictor of the current block by using reconstructed samples or predicted samples of the current block as input to a filter to generate samples of the predictor; and
encoding the current block by using the predictor.
